(19) United States
(12) Patent Application Publication
(10) Pub. No.: US 2025/0073895 A1
(43) Pub. Date: Mar. 6, 2025

(54) MULTILAYER EXTENDABLE ACTUATOR

(71) Applicant: National University of Singapore, Singapore (SG)

(72) Inventors: Jonathan William AMBROSE, Singapore (SG); Chen Hua YEOW, Singapore (SG)

(21) Appl. No.: 18/553,970

(22) PCT Filed: Apr. 8, 2022
(86) PCT No.: PCT/SG2022/050203

§ 371 Date: Oct. 4, 2023

(30) Foreign Application Priority Data
Apr. 8, 2021 (SG) 10202103623X

(51) Int. Cl. B25J 9/14; B25J 9/10; B29K 21/00; B29L 31/00; B33Y 10/00; B33Y 50/02; B33Y 80/00; B62D 57/032; F15B 15/02; F15B 15/08

(52) U.S. Cl. CPC B25J 9/142; B25J 9/1075; B25J 9/144; B33Y 80/00; B62D 57/032; F15B 15/02; F15B 15/08; B29K 2021/003; B29L 2031/748; B33Y 10/00; B33Y 50/02

(57) ABSTRACT

The present disclosure generally relates to a multilayer extendable actuator. The actuator comprises: a first stiffening elastomeric layer; a second stiffening elastomeric layer; a set of middle layers disposed between the stiffening elastomeric layers, the middle layers comprising an elastic elastomeric layer that is more elastic than the stiffening elastomeric layers; and a set of grooves through one or more of the elastomeric layers, the grooves arranged such that a cross-section of the elastomeric layers comprises a wave profile around the grooves, wherein the actuator is extendable such that the elastomeric layers along the wave profile become alternatingly arranged along the extended actuator.

### CROSS REFERENCE TO RELATED APPLICATIONS

The present disclosure claims the benefit of Singapore patent application Ser. No. 10202103623X filed on 8 Apr. 2021, which is incorporated in its entirety by reference herein.

### TECHNICAL FIELD

The present disclosure generally relates to a multilayer extendable actuator. More particularly, the present disclosure describes various embodiments of the multilayer extendable actuator, as well as assemblies comprising the actuator.

### BACKGROUND

In the field of robotics, actuators are components that act as the muscles of robotic systems. Many robotic systems use rigid actuators that could pose difficulties in certain situations, for example when working safely in close contact with people or with delicate objects. Soft actuators for robotics have been developed to address the problems of rigid actuators. Soft actuators are known for their compliance, safety, and adaptability, and they have many applications such as in manufacturing, healthcare, and disaster relief. One common way of actuating soft actuators is by pneumatic means due to its ease of use, inherent safety, and overall compliance compared to other fluidic actuation means. For example, soft pneumatic actuators have been implemented for various applications such as manipulation, locomotion, assistive devices, and end effectors like grippers and surgical devices. However, current soft pneumatic actuators have limited range of motions and can only be used for limited applications. When considering a new application of an existing actuator, the actuator often requires significant redesigning which is resource intensive. Current soft pneumatic actuators are generally useful in the specific applications they are designed for, but they usually lack the versatility to be redeployed to other applications.

Therefore, in order to address or alleviate at least one of the aforementioned problems and/or disadvantages, there is a need to provide an improved actuator.

### SUMMARY

According to an aspect of the present disclosure, there is a multilayer extendable actuator comprising: a first stiffening elastomeric layer; a second stiffening elastomeric layer; a set of middle layers disposed between the stiffening elastomeric layers, the middle layers comprising an elastic elastomeric layer that is more elastic than the stiffening elastomeric layers; and a set of grooves through one or more of the elastomeric layers, the grooves arranged such that a cross-section of the elastomeric layers comprises a wave profile around the grooves, wherein the actuator is extendable such that the elastomeric layers along the wave profile become alternatingly arranged along the extended actuator.

A multilayer extendable actuator according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 shows illustrations of a multilayer extendable actuator according to embodiments of the present disclosure.

FIG. 2 shows illustrations of various designs of the actuator.

FIGS. 3a to 3b shows tables of various properties of the actuator designs.

FIGS. 4a to 4d show illustrations of test results on extension and force output of the actuator designs.

FIGS. 5a to 5e show illustrations of test results on block force of the actuator designs.

FIGS. 6a to 6d show illustrations of push, pull, bend, and twist configurations of the actuator.

FIGS. 7a to 7j show illustrations of a gripper assembly comprising the actuator.

FIG. 8 shows other illustrations of the gripper assembly.

FIG. 9 shows illustrations of a modular arm assembly comprising the actuator.

FIG. 10 shows illustrations of various designs of the modular arm assembly.

FIGS. 11a to 11c show illustrations of test results on flexion angle of the modular arm assembly.

FIG. 12 shows illustrations of a locomotion robot comprising the actuator.

FIG. 13 shows illustrations of a gear-pulley assembly comprising the actuator.

FIG. 14 shows illustrations of an extendable actuation device comprising a plurality of the actuators.

FIG. 15 shows illustrations of the extendable actuation device being an artificial muscle unit.

FIG. 16 shows illustrations of a moulding process for fabricating the actuator.

FIGS. 17a to 17c show illustrations of a large actuator.

FIGS. 18a to 18c show illustrations of the actuator fabricated by 3D printing.

FIGS. 19a to 19b show illustrations of test results on extension of moulded and 3D-printed actuators.

FIGS. 20a to 20b shows illustrations of test results on force output of moulded and 3D-printed actuators.

FIG. 21 shows illustrations of a 3D-printed artificial muscle unit comprising a plurality of 3D-printed actuators.

FIG. 22 shows an illustration of test results on strain of the 3D-printed artificial muscle units.

FIGS. 23a to 23d show illustrations of test results on force output of the 3D-printed artificial muscle units.

FIG. 24 shows illustrations of a bicep artificial muscle unit comprising a plurality of 3D-printed artificial muscle units.

FIG. 25 shows illustrations of the bicep artificial muscle unit with a dummy arm.

FIG. 26 shows illustrations of the bicep artificial muscle unit with an arm assembly.

FIG. 27 shows an illustration of a garment comprising the actuators.

### DETAILED DESCRIPTION

For purposes of brevity and clarity, descriptions of embodiments of the present disclosure are directed to a multilayer extendable actuator, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith.

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment.

As used herein, the terms “a” and “an” are defined as one or more than one. The use of “/” in a figure or associated text is understood to mean “and/or” unless otherwise indicated. The term “set” is defined as a non-empty finite organization of elements that mathematically exhibits a cardinality of at least one (e.g. a set as defined herein can correspond to a unit, singlet, or single-element set, or a multiple-element set), in accordance with known mathematical definitions. The recitation of a particular numerical value or value range herein is understood to include or be a recitation of an approximate numerical value or value range. The terms “first”, “second”, etc. are used merely as labels or identifiers and are not intended to impose numerical requirements on their associated terms.

### Actuator

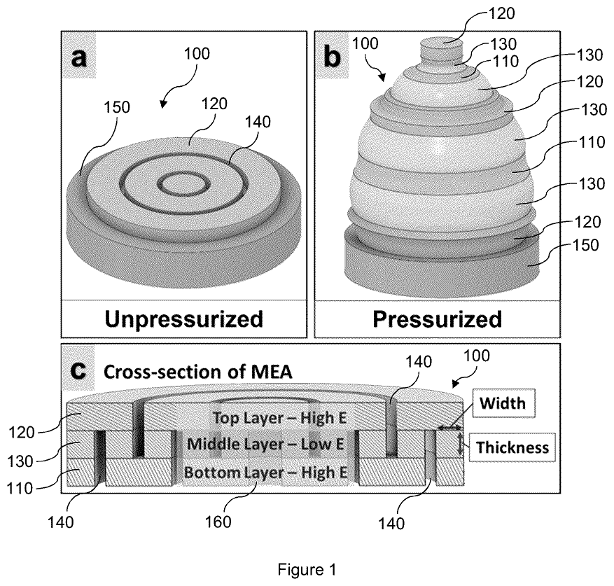

In representative or exemplary embodiments of the present disclosure, there is a multilayer extendable actuator 100 as shown in FIG. 1. FIG. 1a shows the actuator 100 in the unextended or compact state, FIG. 1b shows the actuator 100 in the extended state, and FIG. 1c shows a cross-section of the actuator 100. The actuator 100 includes a first stiffening elastomeric layer 110, a second stiffening elastomeric layer 120, and a set of middle layers disposed between the stiffening elastomeric layers 110,120.

The middle layers include an elastic elastomeric layer 130 that is more elastic than the stiffening elastomeric layers 110,120 which may have equal stiffnesses. For example, the elastomeric layers 110, 120, 130 are made of elastomeric materials (e.g. silicone), wherein the elastomeric material for the stiffening elastomeric layers 110,120 have a greater modulus of elasticity (or Young's modulus E) than the elastomeric material for the elastic elastomeric layer 130.

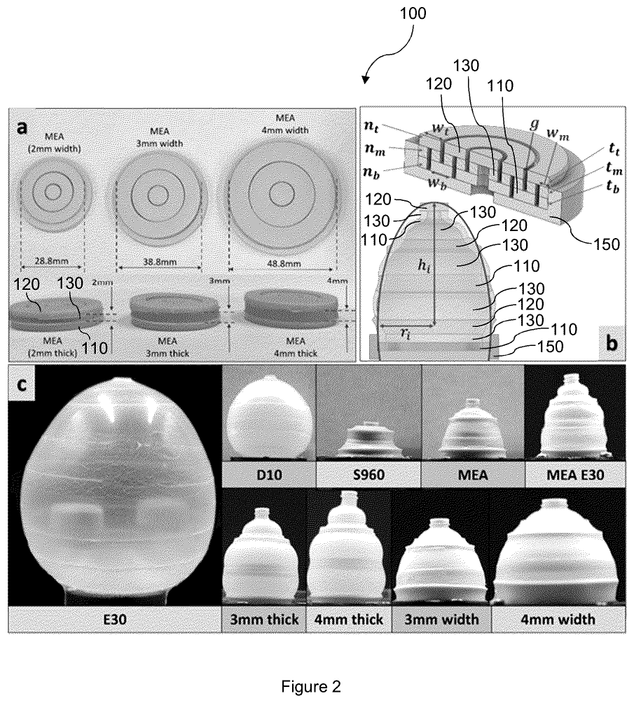

The actuator 100 further includes a set of grooves 140 through one or more of the elastomeric layers 110,120,130. The grooves 140 are arranged such that a cross-section of the elastomeric layers 110,120,130 includes a wave profile around the grooves 140. For example, the wave profile includes a square wave profile. For example, the grooves 140 are formed as one or more rings around a centre of the respective elastomeric layer 110,120,130. Notably, as shown in FIG. 2b, the stiffening elastomeric layers 110,120 form the crests and troughs of the wave profile, and the elastic elastomeric layer 130 forms the middle of the wave profile. The actuator 100 is extendable such that the elastomeric layers 110,120,130 along the wave profile become alternatingly arranged along the extended actuator 100. For example, the actuator 100 is extendable along an axial direction perpendicular to the propagation direction of the wave profile. In the extended state as shown in FIG. 1b, the elastomeric layers 110,120,130 are alternatingly arranged along the axial direction. More specifically, each section of the elastic elastomeric layer 130 is interposed between two sections of the first stiffening elastomeric layer 110 and/or second stiffening elastomeric layer 120. For example, a section of the elastic elastomeric layer 130 may be disposed between two sections of the first stiffening elastomeric layer 110, a section of the elastic elastomeric layer 130 may be disposed between two sections of the second stiffening elastomeric layer 120, and a section of the elastic elastomeric layer 130 may be disposed between a section of the first stiffening elastomeric layer 110 and a section of the second stiffening elastomeric layer 120.

The actuator 100 may include an outer body 150, such as a rigid shell, for supporting the elastomeric layers 110,120,130, wherein the first stiffening elastomeric layer 110 is attached to the outer body 150. The actuator 100 may include a channel 160 extending through at least the first stiffening elastomeric layer 110, and optionally further through the elastic elastomeric layer 130, for receiving pressurized fluid (such as pressurized or compressed air) for extending the actuator 100. For example, the grooves 140 at the respective centres of the first stiffening elastomeric layer 110 and elastic elastomeric layer 130 form the channel 160.

When the actuator 100 is in the unextended state such as when unpressurized, the wave profile works like a spring and provides an initial tension in the actuator 100. This initial tension biases the actuator 100 towards the unextended state and allows the actuator 100 to be compact when unpressurized. When the actuator 100 is in the extended state such as when pressurized, the wave profile unfolds and extends and enables the extended actuator 100 to exhibit a telescopic profile. The stiffening elastomeric layers 110, 120 restrict the radial expansion of the actuator 100 and further propel its extension. The multilayer structure and the wave profile of the actuator 100 enable the actuator 100 to increase its extension, increase its ability to withstand higher input pressure, increase its force output, and increase its durability.

In many embodiments, the stiffening elastomeric layers 110,120 are made of Smooth-Sil™ 960 (S960) silicone (Shore hardness 60A and E=288 psi) and the elastic elastomeric layer 130 is made of Dragon Skin™ 10 (D10) silicone (Shore hardness 10A and E=90 psi). In some embodiments, the elastic elastomeric layer 130 can be made of Ecoflex™ 00-30 (E30) silicone (Shore hardness 00-30 and E=43 psi).

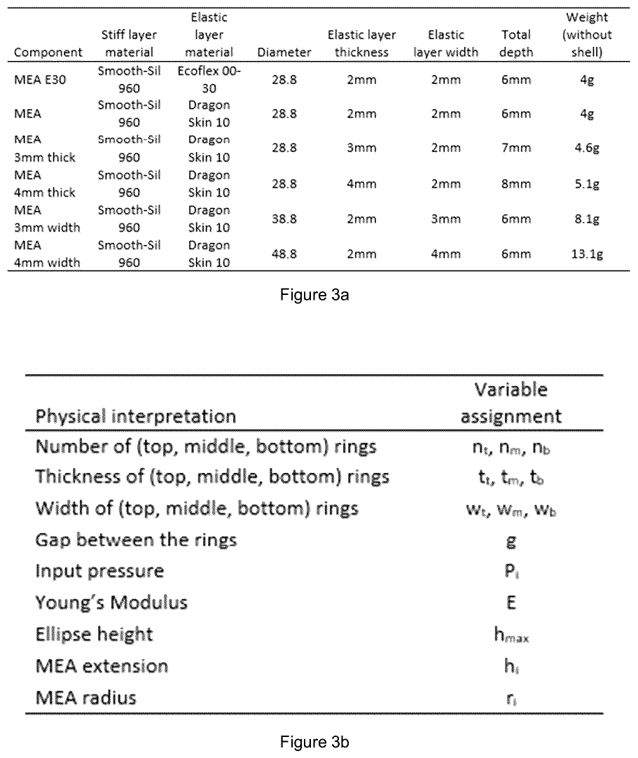

FIGS. 2a and 2c show various exemplary designs of the actuator 100. In one design denoted as “MEA”, the stiffening elastomeric layers 110,120 are made of S960 silicone and the elastic elastomeric layer 130 is made of D10 silicone. The elastic elastomeric layer 130 has a thickness (tₘ) of 2 mm and a width (wₘ) of 2 mm, and the grooves 140 have a gap (g) of 0.8 mm between the ring sections of the elastomeric layers 110, 120, 130. In one design denoted as “MEA E30”, it is the same as the “MEA” design except the elastic elastomeric layer 130 is made of E30 silicone. In one design denoted as “MEA 3 mm thick”, it is the same as the “MEA” design except the thickness (tₘ) of the elastic elastomeric layer 130 is 3 mm. In one design denoted as “MEA 4 mm thick”, it is the same as the “MEA” design except the thickness (tₘ) of the elastic elastomeric layer 130 is 4 mm. In one design denoted as “MEA 3 mm width”, it is the same as the “MEA” design except the width (wₘ) of the elastic elastomeric layer 130 is 3 mm. In one design denoted as “MEA 4 mm width”, it is the same as the “MEA” design except the width (wₘ) of the elastic elastomeric layer 130 is 4 mm. In one design denoted as “D10”, the dimensions are the same as the “MEA” design, but the elastomeric layers 110,120,130 are all made of D10 silicone. In one design denoted as “E30”, the dimensions are the same as the “MEA” design, but the elastomeric layers 110,120,130 are all made of E30 silicone. In one design denoted as “S960”, the dimensions are the same as the “MEA” design, but the elastomeric layers 110,120,130 are all made of S960 silicone. Various parameters from these designs of the actuator 100 are shown in FIGS. 3a and 3b.

Changing these parameters in the various designs of the actuator 100 affects the extension, force output, and durability of the actuator 100. The maximum extension (hₘₐₓ) can be estimated by approximating one side of the perimeter of the actuator 100 (C_{MEA}) as one-quarter of the circumference of an ellipse (Cₑₗₗᵢₚₛₑ), as shown in Equations 1 to 3 below.

$${C}_{MEA} = \frac{1}{4} {C}_{ellipse} \qquad ( 1 )$$

$${C}_{MEA} = ( {n}_{m} - 1 ) ( {w}_{t} + {t}_{m} ( 1 + \frac{{P}_{i}}{E} ) ) + {t}_{t} \qquad ( 2 )$$

$${C}_{ellipse} = 2 π \sqrt{\frac{{r}_{i}^{2} + {h}_{max}^{2}}{2}} \qquad ( 3 )$$

The extension (hᵢ) of the actuator 100 can be approximated by assuming a proportional relationship with the input pressure of the pressurized fluid using Equation 4. At this extension (hᵢ), the tip force (Fᵢ) at the end of the actuator 100 can be approximated by based on the contact area (A) at the end of the actuator 100 using Equation 5.

$${h}_{i} = {h}_{max} \frac{{P}_{i}}{{P}_{max}} \qquad ( 4 )$$

$${F}_{i} = {P}_{i} A \qquad ( 5 )$$

Each design of the actuator 100 was tested to measure the maximum input pressure (Pₘₐₓ) the actuator 100 can withstand before it fails. Each actuator 100 includes the outer body 150 that was mounted to a flat platform for the measurements. A camera was used to capture images of the actuators 100 at the maximum input pressure, as shown in FIG. 2c. The maximum input pressures guided tests on the actuators 100 to prevent premature failures of the actuators 100 during these tests. If the maximum input pressure for an actuator 100 is below 100 kPa, the maximum safe pressure was set at 20 kPa below that. If the maximum input pressure is 100 kPa or more, the maximum safe pressure was set at 30 kPa below that.

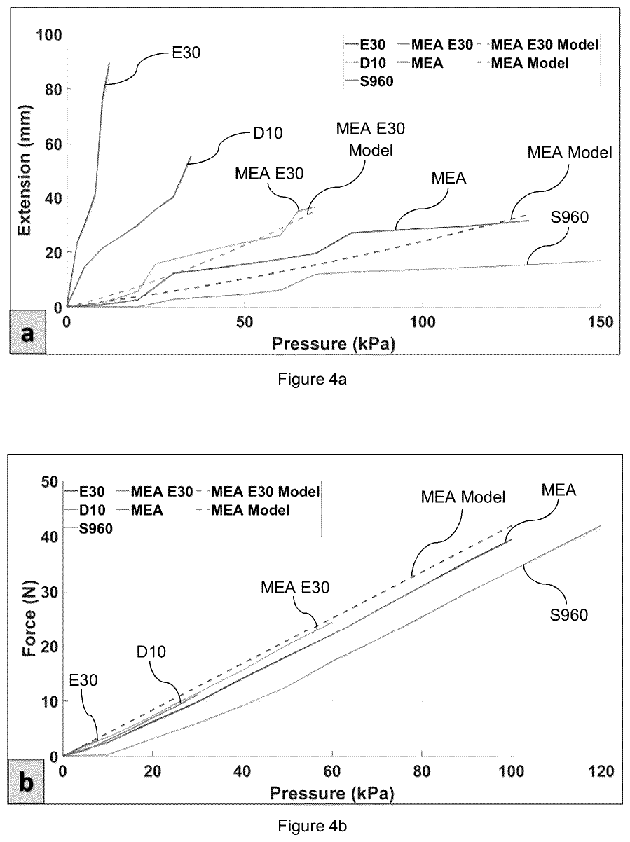

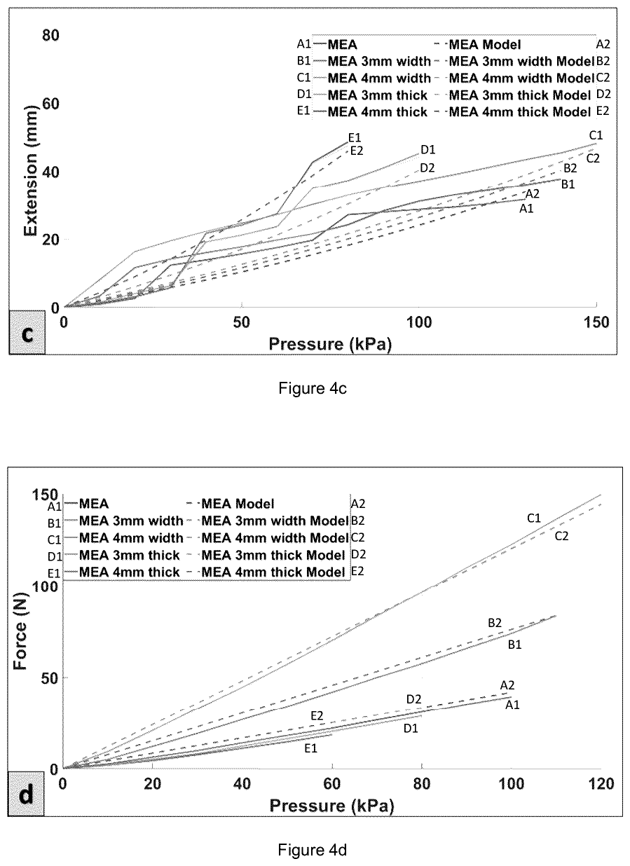

The force output at the tips of the actuators 100 were tested using an automatic vertical pull test machine. Each actuator 100 was placed in direct contact with the load cell to measure the block force as the input pressure increases until the respective maximum safe pressure. The extensions of the actuators 100 were also measured at the same time. FIGS. 4a and 4b show the test results for the E30, D10, S960, MEA, and MEA E30 designs, together with computer models of the MEA and MEA E30 designs. FIGS. 4c and 4d show the test results for the MEA, MEA 3 mm width, MEA 4 mm width, MEA 3 mm thick, and MEA 4 mm thick designs, together with their corresponding computer models.

In the test results shown in FIGS. 4a and 4b, the MEA design was compared to other actuator designs with single materials, i.e. the E30, D10, and S960 designs. The E30 and D10 designs were capable of high maximum extensions of 89.4 mm and 55.7 mm, respectively, but they have low maximum input pressures of 12 kPa and 35 kPa, respectively, and correspondingly low maximum force outputs of 3.4 N and 11.4 N, respectively. The low maximum safe pressures and maximum force outputs are likely due to the low-pressure limit of the E30 and D10 silicones. The S960 design has high maximum input pressure of 150 kPa, and correspondingly high maximum force output of 41.9 N, but has low maximum extension of 16.9 mm. The MEA E30 and MEA designs, which combined the S960 and E30/D10 silicones, were capable of maximum extensions of 36.6 mm and 31.5 mm, respectively, and have maximum input pressures of 70 kPa and 130 kPa, respectively, corresponding to maximum force outputs of 21.5 N and 39.4 N, respectively.

In the test results shown in FIGS. 4c and 4d, the MEA design was compared to other actuator designs with increased thickness and/or width. The MEA 3 mm thick and MEA 4 mm thick designs were capable of maximum extensions of 45.2 mm and 48.5 mm, respectively, and have maximum input pressures of 100 kPa and 80 kPa, respectively, corresponding to maximum force outputs of 28.7 N and 18.4 N, respectively. The MEA 3 mm width and MEA 4 mm width designs were capable of maximum extensions of 37.7 mm and 48.5 mm, respectively, and have maximum input pressures of 140 kPa and 150 kPa, respectively, corresponding to maximum force outputs of 83.7 N and 149.7 N, respectively.

The test results showed that the extensions of the actuators 100 exhibited a non-linear relationship with respect to input pressure. The computer models also closely predict the behaviour of the actuators 100 in response to increasing the input pressure. This behaviour due to the wave profile in the cross-section of the elastomeric layers 110,120,130, where the troughs of the wave profile would rearrange themselves to unfold and extend. When given sufficient input pressure, the actuator 100 would exhibit a sharper extension at certain input pressures which creates the telescopic profile. This could be attributed to the initial tension from the wave profile and elastomeric materials, such that a minimum input pressure was required to unfold and extend the next section of the wave profile.

Moreover, the MEA designs of the actuators 100 allow them to withstand higher input pressure, increase durability, and increase force output, but with some reduction in extension. Notably, the MEA E30 design was able to withstand approximately 4.8 times more input pressure than the E30 design, and achieve approximately 1.2 times more extension than the S960 design. The MEA design was able to withstand approximately 2.7 times more input pressure than the D10 design, and achieve approximately 0.9 times more extension than the S960 design. This was likely due to the telescopic profile of the extended actuator 100 combined with the initial tension, resulting in the MEA design's ability to perform better than the S960 design.

Although increasing the thickness of the elastic elastomeric layer 130 increases the extension, the durability was reduced, likely due to the increased thickness causing additional strain which would result in more deformation and consequently early failure. The MEA E30 design similarly had better extension and force output than the MEA design despite having the same contact area at the end of the actuator 100. This suggests that some force was lost due to the initial tension from the wave profile. Increasing both the thickness and width of the elastic elastomeric layer 130 improves both extension and durability. The improvement in durability was likely due to the larger bonding area between the elastic elastomeric layer 130 and the stiffening elastomeric layers 110,120, which creates a stronger hold between them to withstand higher input pressures. It is also worth noting that increasing the width reduced the telescopic profile of the extended actuator 100, making it more spherical than conical, as shown in FIG. 2c.

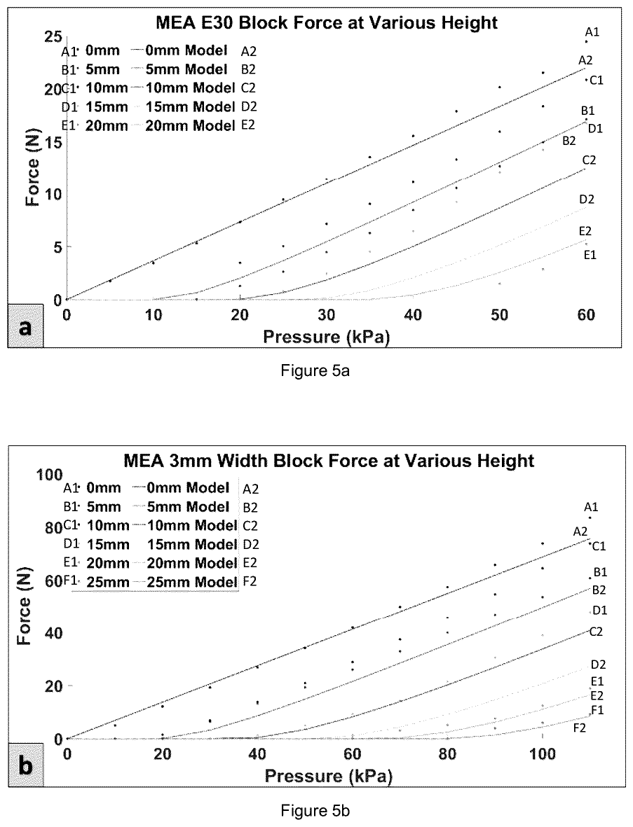

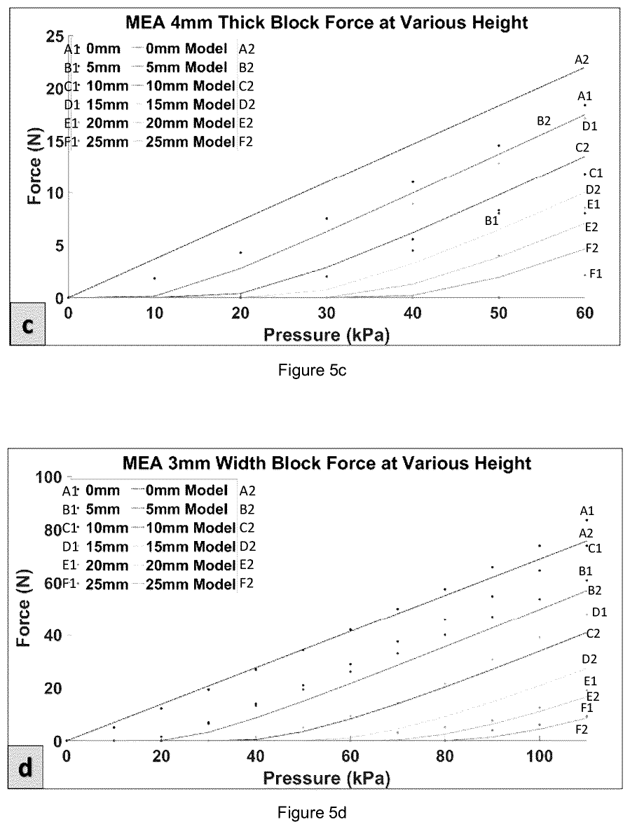

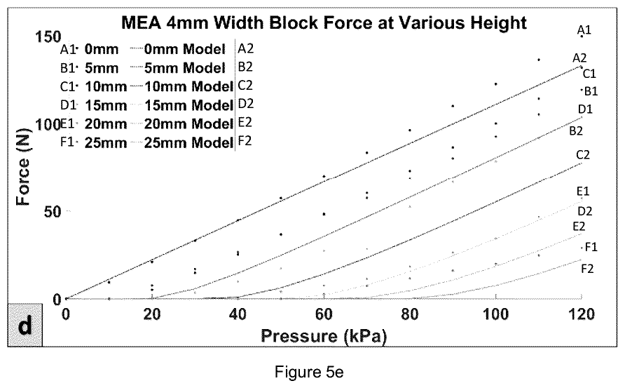

The block force tests were repeated at various heights between the load cell and the actuators 100 to measure the tip force as the actuator 100 extends. The heights start at 0 mm and increase at 5 mm increments until 25 mm, except for the MEA E30 design which is capped at 20 mm. FIGS. 5a to 5e show the test results at these heights for the various MEA designs, together with their corresponding computer models. The test results showed that the force outputs were reduced when the height increased. This was due to the longer extension required to reach the load cell which sharpens the telescopic profile of the extended actuator 100 and reduces the contact area at the end of the actuator 100, thus reducing the force output.

Moreover, the wave profile of MEA designs with thicker elastic elastomeric layers 130 did not evenly unfold out vertically, but instead unfolded at a corner, resulting in the actuators 100 unable to contact the load cell. This was due to increased frictional forces caused by the narrow grooves 140 between the ring sections of the elastomeric layers 110, 120, 130. The computer models broadly predict the behaviour of the force outputs of the actuators 100 at the various heights using a truncated cone formula, though the behaviour was less accurately predicted for MEA designs with increased widths.

A cyclic durability test was performed on the MEA, MEA 3 mm width, and MEA 4 mm width designs to evaluate their durability with respect to the maximum safe pressures, which were 100 kPa, 110 kPa, and 120 kPa, respectively. These actuators 100 failed on average after 463, 255, and 357 cycles, respectively, at their maximum safe pressures.

Therefore, the alternating arrangement of the elastomeric layers 110, 120, 130 of different stiffnesses/elasticities enables the actuator 100 to increase its extension, ability to withstand higher input pressure, force output, and durability, and the initial tension which biases the actuator 100 towards the unextended date without external stimulus. The compact/slim form of the actuator 100 in the unextended state allows the actuator 100 to extend more quickly outwards. These properties can be changed by changing various parameters of the actuator 100, such as materials and dimensions.

### Actuator Configurations

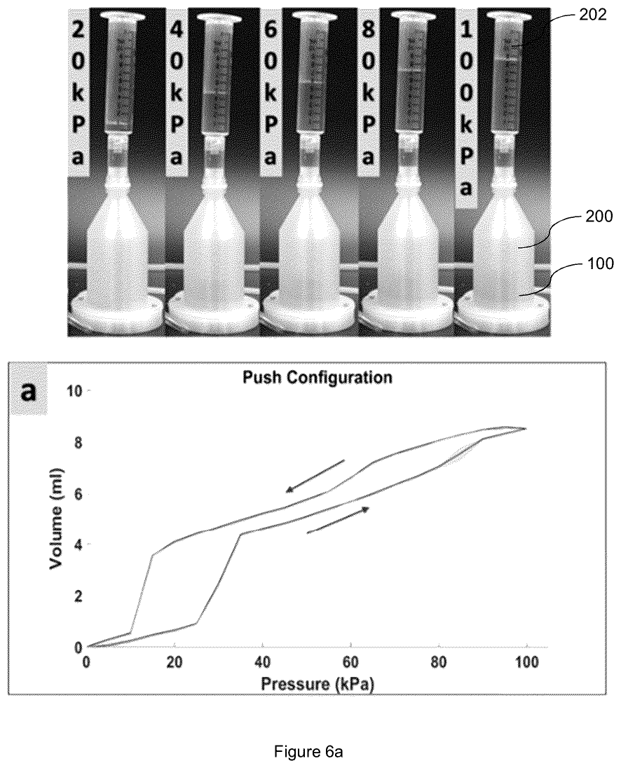

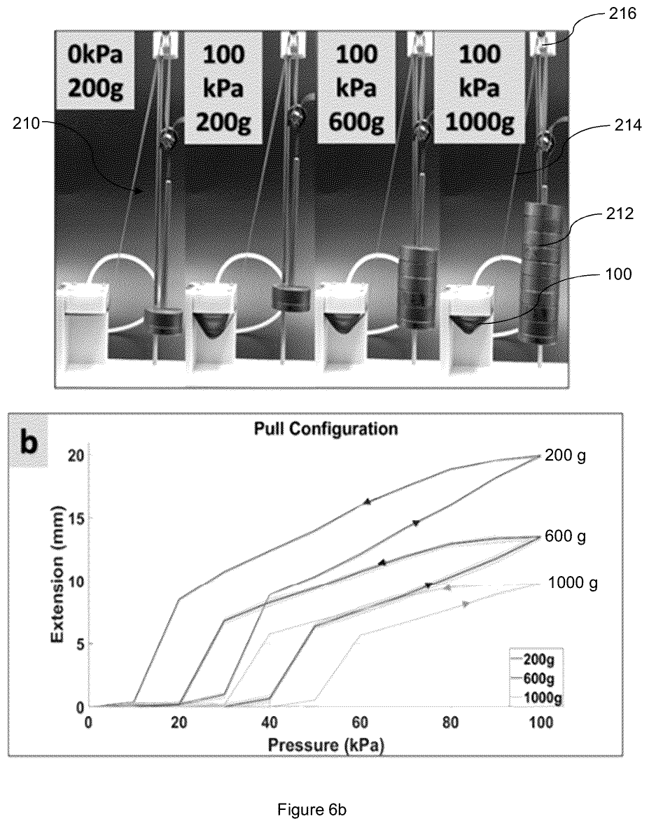

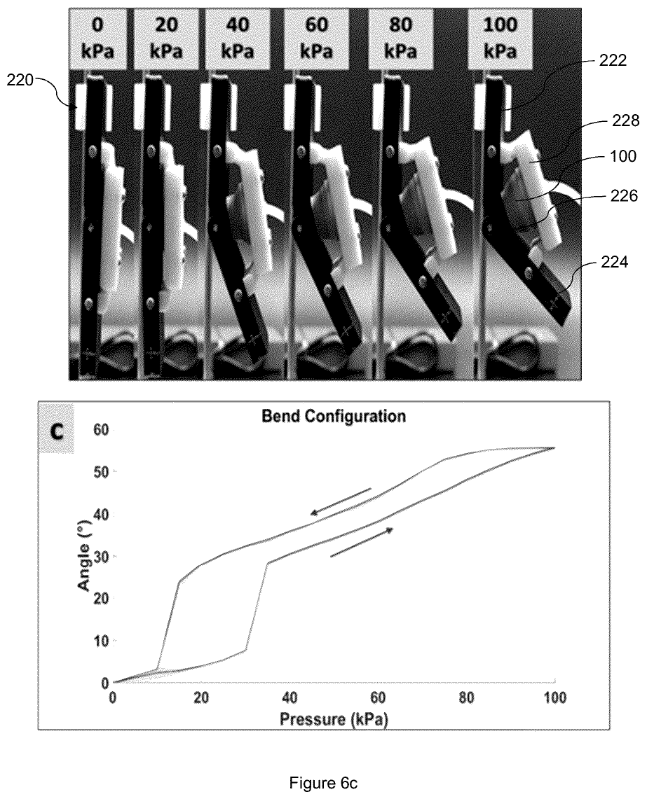

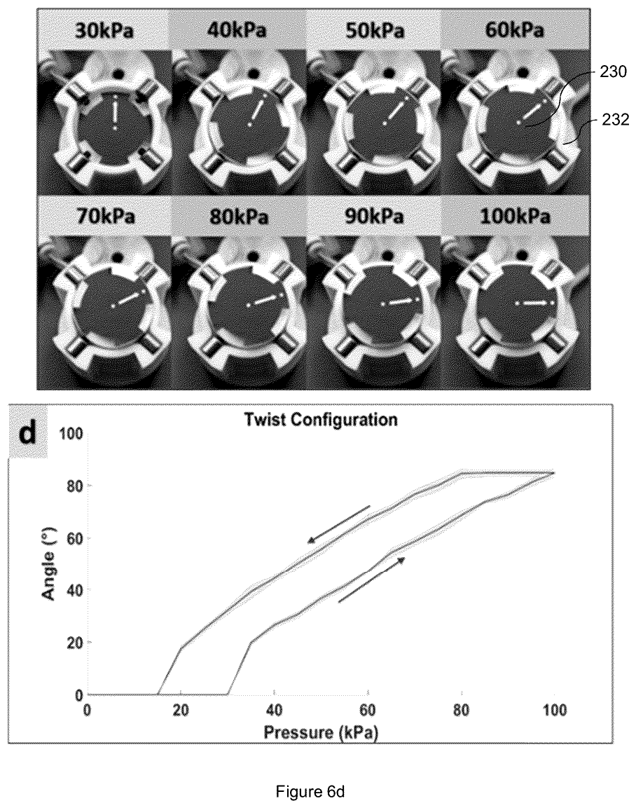

The actuator 100 has the versatility to be deployed in various configurations to translate the linear motion of the actuator 100 into various output motions. Specifically, the actuator 100 can be configured to translate its linear extension into four basic motions, namely push, pull, bend, and twist. The MEA design of the actuator 100 was assembled into various configurations to test the four basic motions. The configurations and test results are shown in FIG. 6. The tests were performed during the extension phase from the unextended state to the extended state at the maximum safe pressure of 100 kPa, and also during the retraction phase from the extended state back to the unextended state.

In the push configuration as shown in FIG. 6a, the actuator 100 was housed in water-filled container 200 and a syringe 202 was connected to the top of the container 200. When the actuator 100 extends, the actuator 100 pushes up the water in the container 200 towards the syringe which then measure the volume of water displaced. The maximum volume displaced was 8.5 ml at the maximum safe pressure. This test also demonstrated that the actuator 100 can be used underwater.

In the pull configuration as shown in FIG. 6b, a pulley mechanism 210 was used to translate the force output from the actuator 100 to pull various weights 212. The pulley mechanism 210 included a pulley belt 214 that was made of nylon fabric. The pulley belt 214 was overlaid on the actuator 100, over the pulley wheel 216, and attached to the weights 212. When the actuator 100 extends, it pushes onto the pulley belt 214 and thereby pulls the weights 212. Weights 212 of 200 g, 600 g, and 1 kg were used to test the pulling capabilities of a single actuator 100. Heavier weights reduced the maximum extension of the actuator 100. The maximum extensions from pulling the weights 212 were 19.9 mm, 13.5 mm and 9.8 mm, respectively, at the maximum safe pressure.

In the bend configuration as shown in FIG. 6c, a bending arm mechanism 220 was used to test the force output from the actuator 100 to achieve bending motion in the bending arm mechanism 220. The bending arm mechanism 220 includes a proximal arm 222, a distal arm 224, and a hinge joint 226 connecting them. The proximal arm 222 was clamped and the actuator 100 was fixed against the hinge joint 224. A flexible member 228 connects across the proximal arm 222, distal arm 224, and actuator 100. When the actuator 100 extends, it pushes the flexible member 228 which forces the distal arm 224 to flex towards the proximal arm 222, forming a flexion angle at the hinge joint 226 between the arms 222,224. The flexion angle increases as the actuator 100 extends. The maximum flexion angle was 55.5° at the maximum safe pressure.

In the twist configuration as shown in FIG. 6d, a rotatable puck 230 and the actuator 100 were assembled to an outer enclosure 232. The rotatable puck 230 was attached to the end of the actuator 100 and when the actuator 100 extends, it induces the puck 230 to rotate against the outer enclosure 232. As the actuator 100 extends, the contact area between the end of the actuator 100 and the puck 230 decreases, thus reducing frictional forces and allowing the puck 230 to rotate against the outer enclosure 232. The maximum rotation was 84.8° at the maximum safe pressure.

Hysteresis was observed in all four configurations which could be due to the elasticity of the elastomeric materials used in the actuator 100 and to the telescopic profile of the actuator 100 which requires more energy to unfold but less energy to maintain the telescopic profile. Additionally, it was observed that the extended actuator 100 has an innate ability to retract back to its unextended state on its own when the input pressure was reduced. This was due to the biasing effect of the initial tension from the wave profile.

### Actuator Applications

The actuator 100 can be used in various applications, particularly robotic applications. In some of these applications, there is an actuation assembly that includes a set of arms and a set of actuators 100 connected to the arms for actuating the arms.

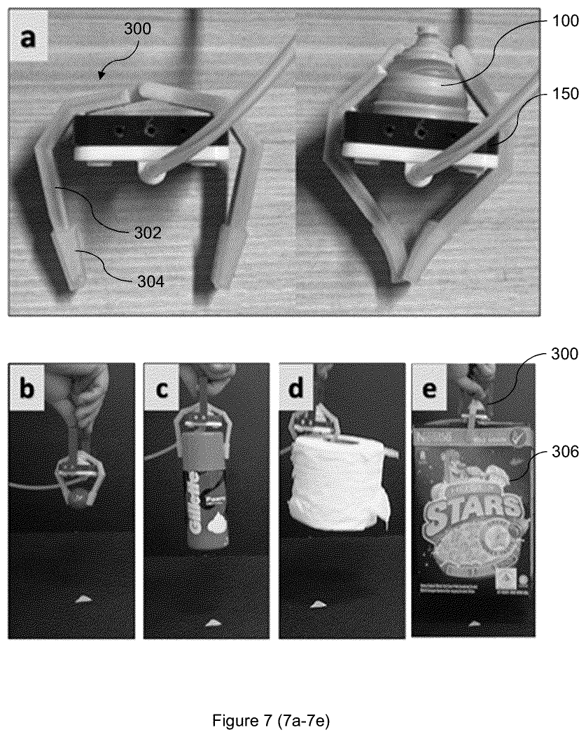

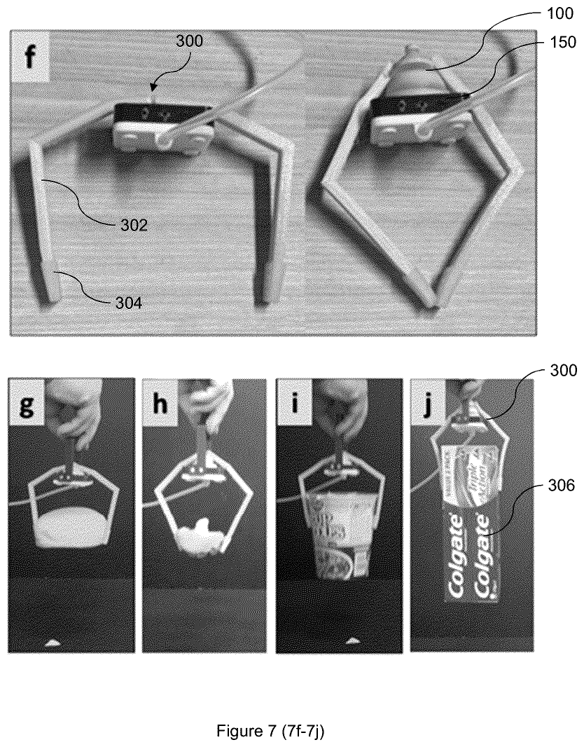

A manipulation application having a gripper assembly 300 is described with reference to FIGS. 7a to 7j. The gripper assembly 300 includes an actuator 100 and a pair of arms or finger modules 302. The finger modules 302 may be made of thermoplastic polyurethane (TPU) embedded with polylactide (PLA). Each finger module 302 may include a fingertip section 304 to provide better rigidity for better force transfer from the actuator 100. The fingertip sections 304 may be coated with a thin layer of elastomeric material, such as D10 silicone, to provide a better grip.

The actuator 100 includes the outer shell 150 that has slots for connecting the finger modules 302 to the actuator 100. The actuator 100 is configured for actuating the finger modules 302. Specifically, the gripper assembly 300 is configured such that extension of the actuator 100 closes the finger modules 302 and retraction of the actuator 100 opens the finger modules 302. The gripper assembly 300 can be designed to be modular and compact and for the finger modules 302 to be swappable. This allows the gripper assembly 300 to be modified with different finger modules 302 to pick up objects 306 of various shapes, sizes, weights, and/or textures.

FIG. 7a shows the gripper assembly 300 having small finger modules 302 and FIG. 7f shows the gripper assembly 300 having large finger modules 302. When the actuator 100 is in the unextended state, the finger modules 302 are open. When the actuator 100 is in the extended state, the finger modules 302 are closed. FIGS. 7b to 7e show the small gripper assembly 300 being used to pick up objects 306 including a cherry tomato, a can of shaving cream, a roll of toilet paper, and a cereal box. FIGS. 7g to 7j show the large gripper assembly 300 being used to pick up objects 306 including a burger bun, broccoli, cup noodles, and a toothpaste box.

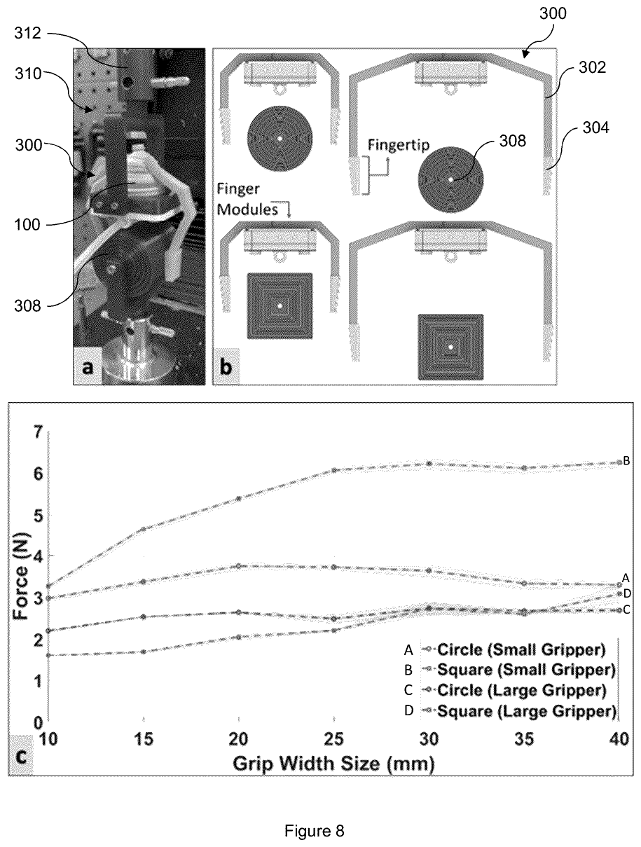

The small and large gripper assemblies 300 were used to grip modular blocks 308 to test the maximum load each gripper assembly 300 can hold before slippage. FIG. 8a shows the test setup 310 using a testing machine 312. The modular blocks 308 were either cylindrical or cuboidal and had various sizes that affected the grip width between the finger modules 302. Further as shown in the CAD diagram in FIG. 8b, the variety of the modular blocks 308 was used to determine if the maximum load was affected by the size of the gripper assembly 300, size of the finger modules 302, grip width, and different contact areas at the fingertip sections 304. The cylindrical and cuboidal blocks 308 had diameters and lengths of 10 mm to 40 mm at 5 mm increments. In the tests, each gripper assembly 300 was actuated at 100 kPa and the finger modules 302 gripped onto the modular block 308. The centre of the fingertip sections 304 was positioned at the centre of the modular block 308. The test machine 312 was then used to pull the gripper assembly 300 away slowly at 2 mm/s.

As shown in FIG. 8c, the test results show the grip force of both gripper assemblies 300 at different grip widths. For the small gripper assembly 300, the grip force on the cylindrical block 308 ranged from 2.98 N to 3.74 N, and the grip force on the cuboidal block 308 ranged from 3.26 N to 6.24 N. For the large gripper assembly 300, the grip force on the cylindrical block 308 ranged from 2.20 N to 2.69 N, and the grip force on the cuboidal block 308 ranged from 1.61 N to 3.08 N.

The small gripper assembly 300 achieved higher grip force on the cuboidal block 308 than on the cylindrical block 308. This was likely due to the fingertip sections 304 having complete contact with the surface of the cuboidal block 308. On the other hand, the large gripper assembly 300 achieved slightly higher grip force on the cylindrical block 308 than on the cuboidal block 308. This was likely due to the sharper angle of the fingertip sections 304 at the bottom half of the cuboidal block 308 which increased the grip force before slippage. The small gripper assembly 300 achieved higher grip force than the large gripper assembly 300 and this can be attributed to the finger modules 302 being slightly compliant or elastic.

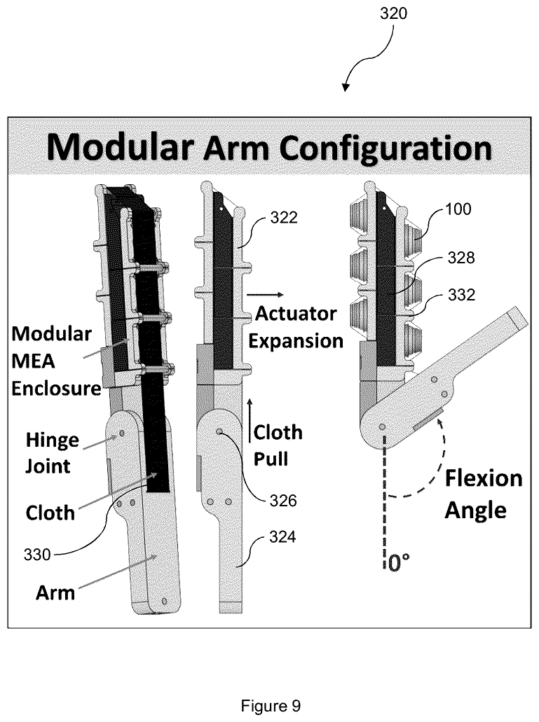

An assistive device application having a modular arm assembly 320 is described with reference to FIG. 9. The modular arm assembly 320 shows how a rigid assembly powered by soft actuators 100. The modular arm assembly 320 includes a set of actuators 100, a proximal arm 322, and a distal arm 324 hinged to the proximal arm 322, and a hinge joint 326 connecting the proximal arm 322 and distal arm 324 to each other. The actuators 100 are connected to the proximal arm 322 for actuating the distal arm 324, i.e. bending the distal arm 324 towards the proximal arm 322. The modular arm assembly 320 allows the arms 322,324 to be fabricated separately and swappable. For example, a larger distal arm 324 can be assembled for carrying heavier objects.

The proximal arm 322 includes an enclosure 328 for housing the actuators 100. The distal arm 324 may be configured to bend to a maximum flexion angle of 130°, similar to a human arm, though it will be appreciated that the flexion angle can be any range. The modular arm assembly 320 includes a cable or belt 330, which can be made of a cloth or fabric material such as nylon, running from the distal arm 324 to around the proximal arm 322 and over the actuators 100. The proximal arm 322 includes metal rods 332 between the actuators 100 to increase displacement of the cable 330 as well as to reduce friction on the cable 330.

To start bending the distal arm 324, the actuator 100 closest to the distal arm 324 is extended first. This pushes the cable 330 outward and pulls the cable 330 away from the distal arm 324, thereby starting to bend the distal arm 324. The adjacent actuator 100 is then extended to further pull the cable 330 and bend the distal arm 324. The actuators 100 are sequentially extended until the distal arm 324 is bent to the desired flexion angle. For example, the actuators 100 on the front side are extended sequentially along the distal-to-proximal direction, and then the actuators 100 on the rear side are extended sequentially along the proximal-to-distal direction. Notably, the sequence of actuating the actuators 100 follows the running direction of the cable 330. This actuation sequence also reduces the friction along the cable 330 and improves torque output on the distal arm 324. It will be appreciated that the modular arm assembly 320 can be modified by adjusting the arrangement and number of actuators 100, such as to arrange the actuators 100 in series and/or parallel. For example, connecting more actuators 100 in series would increase the maximum flexion angle of the distal arm 324, while connecting more actuators 100 in parallel would increase the load capacity of the distal arm 324.

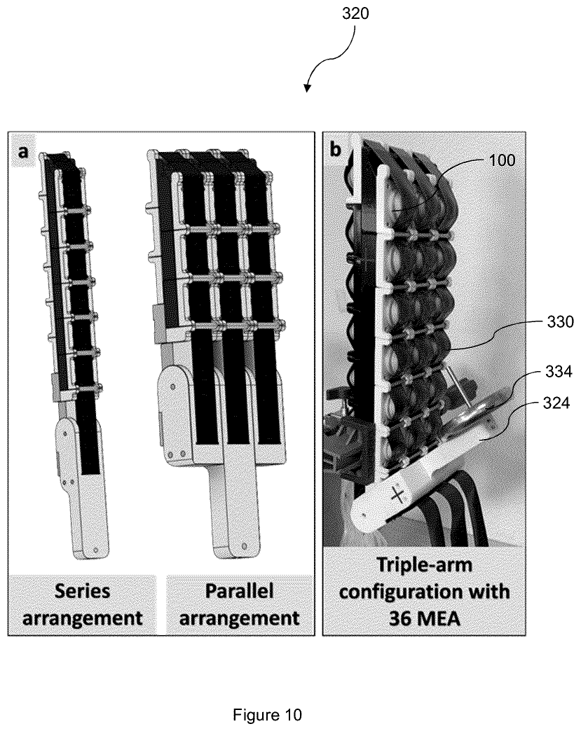

FIG. 10a shows the modular arm assembly 320 having a single-arm configuration wherein 12 actuators 100 are arranged in one row. FIG. 10a, together with FIG. 10b, also shows the modular arm assembly 320 having a triple-arm configuration wherein 36 actuators 100 are arranged in three parallel rows, each row having 12 actuators 100. The modular arm assembly 320 can also have a dual-arm configuration wherein 24 actuators 100 are arranged in two parallel rows, each row having 12 actuators 100.

As shown in FIG. 10b, the dynamic performance of the single-arm, dual-arm, and triple-arm assembles 320 were tested with weights 334 loaded on the distal arm 324. Without any weights 334, the distal arm 324 was bent to the maximum flexion angle of 130° when the actuators 100 were pressurized to 100 kPa. In this test, the actuators 100 were initially in the unextended state, and weights 334 were loaded on the distal arm 324 in 100 g increments. At each weight increment, the actuators 100 were sequentially extended as described above until all the actuators 100 have been pressurized to 100 kPa.

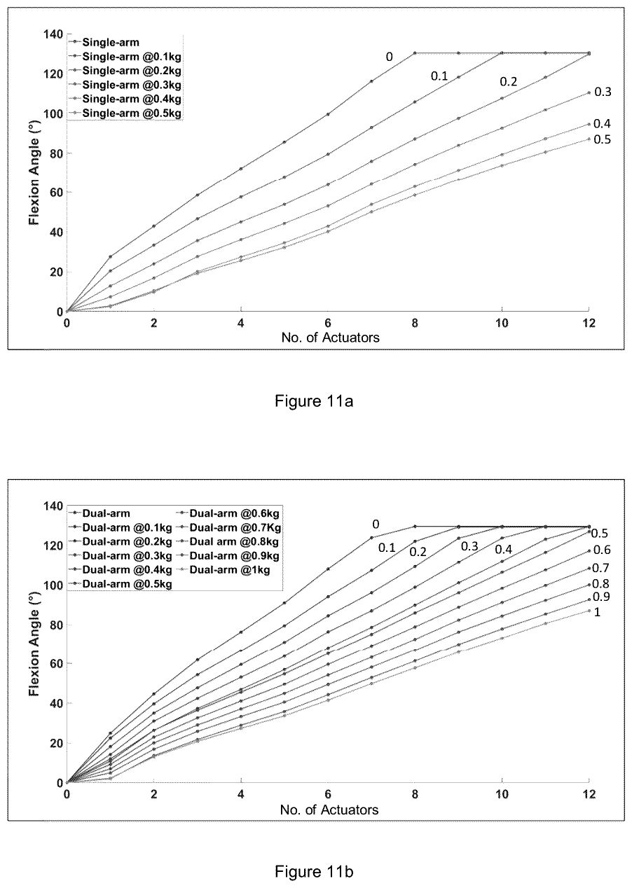

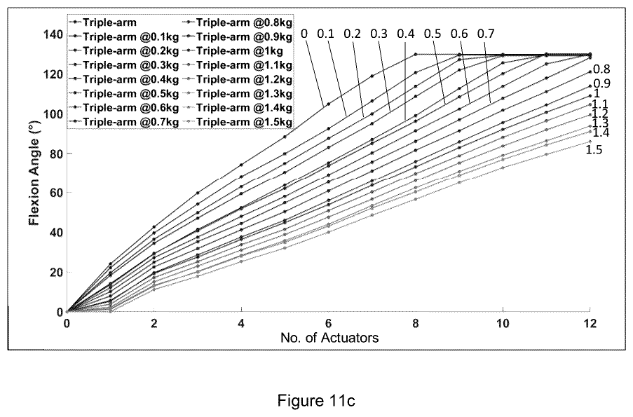

From the performance results of the single-arm, dual-arm, and triple-arm assemblies 320 as shown in FIGS. 11a to 11c, respectively, it was observed that increasing the number of extended actuators 100 resulted in a linear increase in the flexion angle, regardless of single-arm, dual-arm, or triple-arm configurations. It was also observed that the dual-arm and triple-arm assemblies 320 achieved the same dynamic performance even with weights 334 in the same multiple, i.e. twice or thrice, of the single-arm assembly 320. Particularly, the single-arm, dual-arm, and triple-arm assemblies 320 lifted weights 334 of 0.5 kg, 1 kg, and 1.5 kg, respectively, up to a flexion angle of 87.1°, 87.1°, and 86.1°, respectively.

A static loading test was also performed on the modular arm assemblies 320. Firstly, all the actuators 100 were pressurized to 100 kPa and the distal arm 324 was fully bent to the maximum flexion angle of 130° without any weights 334. Secondly, the weights 334 were loaded on the distal arm 324 in 100 g increments until the distal arm 324 deviates away from the maximum flexion angle. The test results showed that there was no flexion angle deviation when the weights 334 were at 2.5 kg. Notably, 2.5 kg approximates the weight of a human arm. The modular arm assembly 320 could be potentially useful for assisted rehabilitation for people, since the distal arm 324 can support considerable static load without flexion angle deviation.

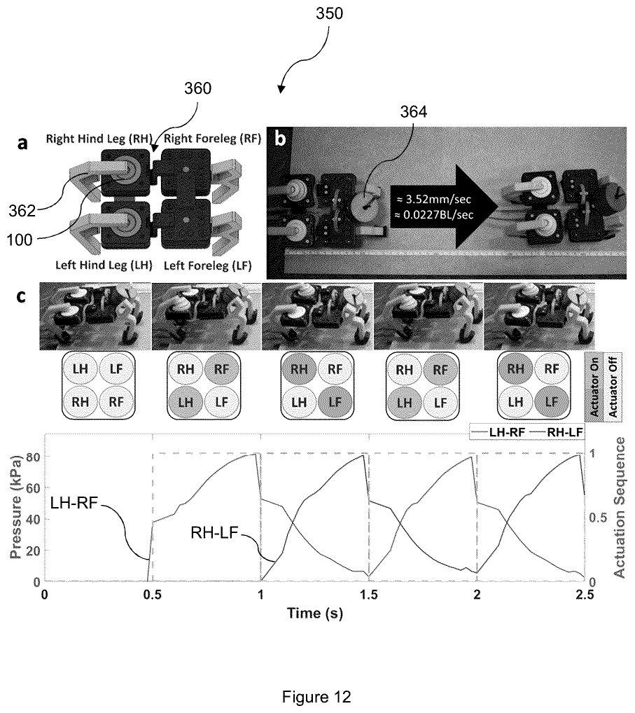

FIG. 12a shows an actuation robot or locomotion robot 350 having a quadrupedal configuration for trotting. The locomotion robot 350 has four sets of actuation assemblies 360 similar to the gripper assembly 300. The actuation assemblies 360 represent the left foreleg (LF), right foreleg (RF), left hindleg (LH), and right hindleg (RH) of the locomotion robot 350. Each actuation assembly 360 includes a leg 362 and an actuator 100 connected to the leg 362 for actuating the leg 362. The actuators 100 are arranged such that when the actuators 100 are extended, the legs 362 are cooperatively actuated to move and push forward the locomotion robot 350. Notably, the actuators 100 for the LF and RF legs 362 are oriented opposite to the actuators 100 for the LH and RH legs 362. The locomotion robot 350 weighs 183 g and spans 155 mm in length. The legs 263 may be made of TPU.

As shown in FIG. 12b, the locomotion robot 350 was tested using a trotting gait cycle. A weight 364 of 200 g was added to increase the ground contact and friction between the legs 362 and the ground. In the trotting gait cycle, diagonal pairs of legs 362 were sequentially actuated simultaneously in this order: LH and RF legs 362 together followed by RH and LF legs 362 together at 0.5 seconds intervals. Further as shown in FIGS. 12c, at 0 to 0.5 seconds, the actuators 100 are in the unextended state. From 0.5 to 1 seconds, the actuators 100 for the LH and RF legs 362 were pressurized simultaneously to 80 kPa to extend the actuators 100 while the actuators 100 for the RH and LF legs 362 remain in the unextended state. From 1 to 1.5 seconds, pressurization of the actuators 100 for the LH and RF legs 362 was stopped and the actuators 100 gradually depressurized and returned to the unextended state, while the actuators 100 for the RH and LF legs 362 were pressurized simultaneously to 80 kPa to extend the actuators 100. From 1.5 to 2 seconds, pressurization of the actuators 100 for the RH and LF legs 362 was stopped and the actuators 100 gradually depressurized and returned to the unextended state, while the actuators 100 for the LH and RF legs 362 were pressurized simultaneously to 80 kPa to extend the actuators 100. From 2 to 2.5 seconds, pressurization of the actuators 100 for the LH and RF legs 362 was stopped and the actuators 100 gradually depressurized and returned to the unextended state, while the actuators 100 for the RH and LF legs 362 were pressurized simultaneously to 80 kPa to extend the actuators 100. The alternating actuation of the LH-RF and RH-LF pairs of legs 362 moved the locomotion robot 350 forward at about 3.52 mm/sec or 0.0227 body lengths per second.

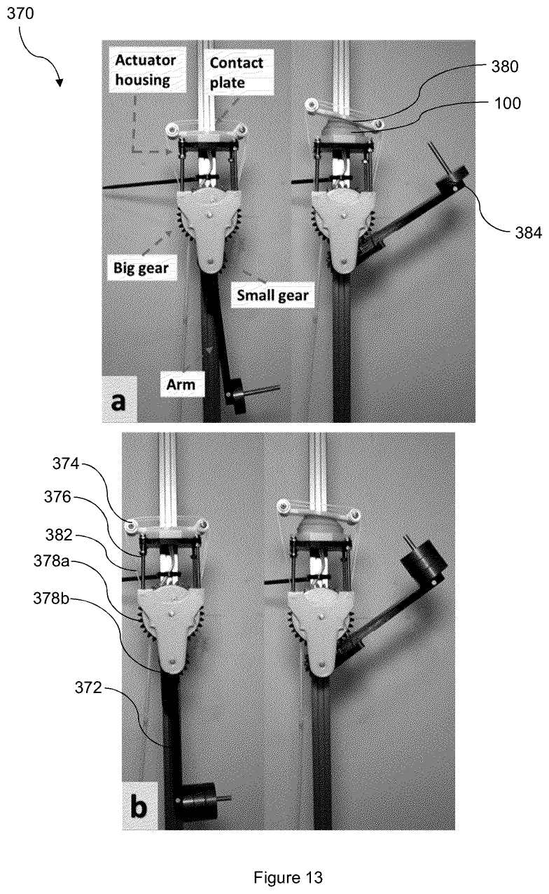

FIGS. 13a and 13b show a gear-pulley assembly 370 similar to the modular arm assembly 320. The gear-pulley assembly 370 includes an arm 372 and an actuator 100 connected to the arm 372 for actuating the arm 372. The gear-pulley assembly 370 further includes a housing 374 for the actuator 100, a set of pulleys 376, and a set of gears 378. The gears 378 include a big gear 378a and a small gear 378b connected to each other, and the small gear 378b is connected to the arm 372. The gear-pulley assembly 370 further includes a contact plate 380 and an actuation line 382 such as a fishing line. The gear-pulley assembly 370 further includes sheaves to connect the actuation line 382 between the pulleys 376 and the big gear 378a, and rotary linear bearings on the sheaves to reduce friction. When the actuator 100 is extended, the extended actuator 100 pushes the contact plate 380 which in turn pushes the pulleys 376 upward. The movement of the pulleys 376 pulls the actuation line 382 which rotates the big gear 378a. The big gear 378a then rotates the small gear 378b which in turn lifts the arm 372. Weights 384 may be loaded on the arm 372 to test the loading capacity of the arm 372. Like the modular arm assembly 320, more actuators 100 can be added in series/parallel to increase the maximum flexion angle and/or lift heavier weights 384. It will be appreciated that the gear ratio of the gears 378 can be changed and the number of pulleys 376 can be changed to modify the gear-pulley assembly 370 according to design requirements. The gear-pulley assembly 370 shows that the soft actuator 100 can be used to complement rigid assemblies and allow them to inherit advantages from both soft components (such as back-drivability and light weight actuators 100) and rigid components (such as accuracy).

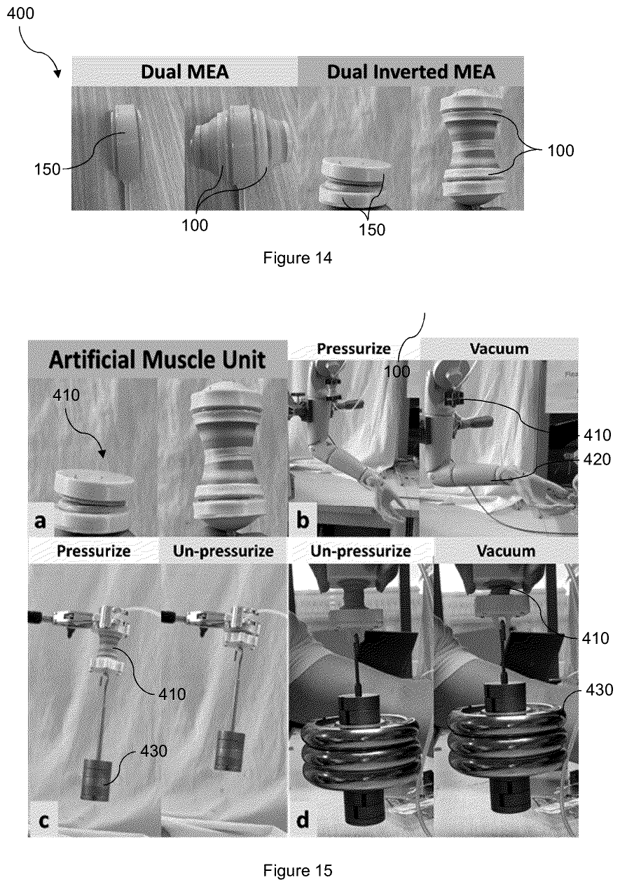

Other applications of the actuator 100 may include connecting a plurality of the actuators 100 together to form an extendable actuation device 400 as shown in FIG. 14. In some embodiments, the actuators 100 are disposed successively on each other in series. For example, two successive actuators 100 are directly connected to each other. In one embodiment denoted as the “Dual MEA” design, the first stiffening elastomeric layers 110 of two successive actuators 100 are arranged to face each other. For example, the outer bodies 150 of the two successive actuators are directly connected to each other. In one embodiment denoted as the “Dual Inverted MEA” design, the second stiffening elastomeric layers 120 of two successive actuators 100 are arranged to face each other.

The Dual MEA and Dual Inverted MEA actuation devices 400 have a bellow-like shape that is potentially capable of more expansion and/or contraction compared to a regular bellow actuator. Such actuation devices 400 can have possible applications for muscle-like actuators using positive and negative pressure (e.g. a vacuum) for pushing and pulling forces. For example, the Dual Inverted MEA actuation device 400 has a larger surface area due to the outer bodies 150 being on the outside. Vacuum can be used to increase the pushing/pulling force due to the larger surface area, allowing the Dual Inverted MEA actuation device 400 to be used for applications that require stronger pushing/pulling forces.

FIG. 15 shows various applications of the Dual Inverted MEA actuation device 400 which can be referred to as an artificial muscle unit (AMU) 410. The AMU 410 was pressurized and depressurized to test its retractability. As shown in FIG. 15a, when the AMU 410 is pressurized to 100 kPa without any load, it was capable of a full extension of 36 mm which is about 3 times its depth in the unextended state. The AMU 410 was then depressurized to determine the duration for the AMU 410 to return to the unextended state. It was observed that the AMU 410, without any load, took 0.122 seconds for full extension and 0.222 seconds to return to the unextended state, providing evidence of the fast actuation of the actuator 100.

As shown in FIG. 15b, the AMU 410 can be coupled to a mannequin or dummy arm 420. The AMU 410 simulates a bicep muscle of the dummy arm 420 to provide elbow flexion and extension upon negative and positive pressure, respectively. As shown in FIGS. 15c and 15d, the AMU 410 was tested on weights 430. The AMU 410 was initially pressurized to 100 kPa to fully extend it. The weights 430 were then added in 100 g increments to determine the maximum load the AMU 410 can hold and self-retract back to the unextended state when the pressurization was stopped. The initial tension of the AMU 410 can be determined from the maximum load. As shown in FIG. 15c, when the pressurization was stopped, it was observed that the AMU 410 was able to self-retract fully back to the unextended state with the maximum load of 0.5 kg. As shown in FIG. 15d, when the pressurization was stopped, it was observed that when the AMU 410 was loaded to 3 kg, the AMU 410 was only able to self-retract partially—the extension of the AMU 410 remained at about 30 mm. In addition to passive depressurization for self-retraction of the AMU 410, a vacuum was used to actively retract the AMU 410 further. It was observed that the vacuum (which is at negative 1 atmospheric pressure) retracted the AMU 410 further by approximately 50% of the 30 mm extension. Given that a single AMU 410 can lift a load of 3 kg, multiple AMUs 410 can be combined in parallel to lift heavier loads. For example, three AMUs 410 can be arranged in parallel to lift a 10 kg load. Further, the lifting capacity of three AMUs 410 can be converted to torque of 3 Nm with a moment arm of 30 mm. The AMU 410 could be useful for applications such as an elbow augmentation sleeve.

These applications of the actuator 100 for manipulation, rehabilitation, and locomotion show the versatility, manipulability, and modularity of the actuator 100. The actuator 100 can be easily integrated into rigid assemblies to achieve a hybrid system of rigid components and soft components. The hybrid system has the advantages of soft robotic actuators such as back-drivability and inherent safety, as well as of rigid robotic components such as accuracy. Further, the actuators 100 are hot-swappable modules that can be replaced within the assemblies, such as to replace faulty actuators 100 or to change to actuators 100 of other designs to reconfigure the assemblies for other applications. For example, more actuators 100 can be arranged in series or parallel to increase the extension or force output, respectively. This versatility of the actuator 100 opens up the possibility of using the same actuator 100 for various applications. In addition to the exemplary applications described above, the actuator 100 may find applications in other areas such as, but not limited to, healthcare, manufacturing, and augmented/virtual reality devices to provide soft and safe feedback to users for immersive experiences.

The actuator 100 described in the present disclosure can be fabricated by hand without special manufacturing equipment and can be mass produced using various manufacturing processes. For example, the actuator 100 can be fabricated by moulding, such as injection moulding, or by additive manufacturing such as 3D printing. Some examples of fabricating the actuator 100 are described below.

### Actuator Moulding

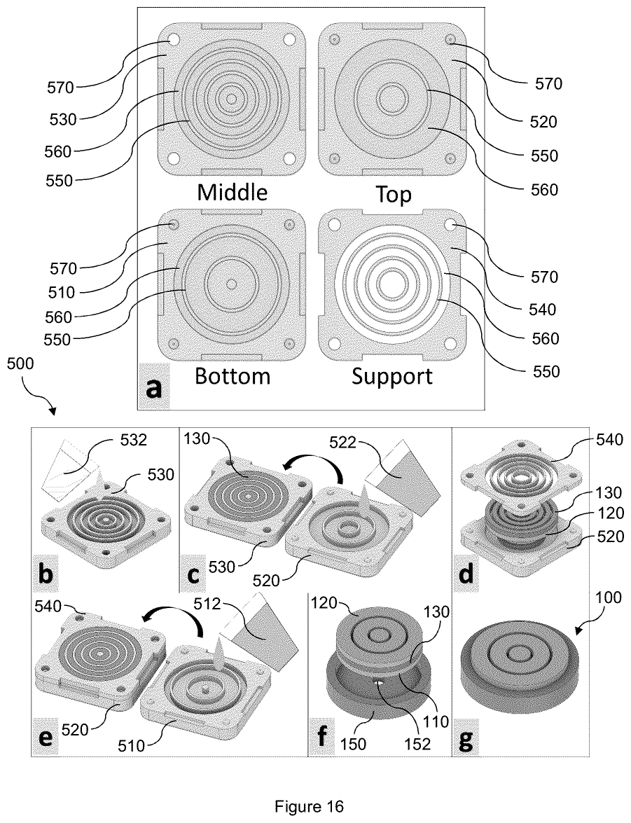

In some embodiments, the actuator 100 is fabricated using a moulding process 500 as shown in FIG. 16. The moulding process 500 can be used regardless of the design variations of the actuator 100, such as different size, number of elastomeric layers 110,120,130, arrangement of grooves 140, and number of ring sections formed by the grooves 140. An exemplary moulding process 500 is described for fabricating an actuator 100 based on the MEA design mentioned above. Specifically, the actuator 100 has the three elastomeric layers 110,120,150, wherein the stiffening elastomeric layers 110,120 are made of S960 silicone and the elastic elastomeric layer 130 is made of D10 silicone. Other elastomeric materials can be used and the moulding process 500 should be adjusted accordingly following the specifications of the elastomeric materials used. For example, the elastic elastomeric layer 130 can be made of E30 silicone instead.

As shown in FIG. 16a, there are four moulds used in the moulding process 500—a bottom mould 510 for moulding the first stiffening elastomeric layer 110, a top mould 520 for moulding the second stiffening elastomeric layer 120, a middle mould 530 for moulding the elastic elastomeric layer 130, and a support mould 540. Each of the moulds 510,520,530,540 has protrusions 550 and channels 560 that form the grooves 140 of the elastomeric layers 110,120,130. Each of the moulds 510,520,530,540 also has markers 570 to guide respective moulds 510,520,530,540 to couple to each other.

The moulding process 500 includes a step of moulding the set of middle layers including the elastic elastomeric layer 130. As shown in FIG. 16b, the elastic elastomeric layer 130 is moulded first. Parts A and B of D10 silicone are weighed and mixed in a ratio of 1:1 by weight. The mixture is placed in a vacuum chamber and degassed for 5 minutes to remove bubbles in the mixture. The degassed mixture 532 is removed from the vacuum chamber and poured into the middle mould 530. A small amount of the degassed mixture 532 may be poured on a flat mould cap for the middle mould 530. The middle mould 530 and flat mould cap containing the degassed mixture 532 are placed in the vacuum chamber for final degassing for 5 minutes. The final degassing removes any remaining bubbles and allows the degassed mixture 532 to conform to the narrow channels 560 of the middle mould 530. After the final degassing, the middle mould 530 and flat mould cap are clamped together and placed in the oven to mould the elastic elastomeric layer 130 at 60° C. for 1 hour. The small amount of mixture 532 on the flat mould cap helps to prevent forming of surface voids on the elastic elastomeric layer 130. After moulding, the middle mould 530 and flat mould cap are removed from the oven and left to cool to cure the elastic elastomeric layer 130.

The moulding process 500 includes steps of moulding one of the first and second stiffening elastomeric layers 110,120 and bonding it to the elastic elastomeric layer 130, and moulding the other of the first and second stiffening elastomeric layers 110,120 and bonding it to the elastic elastomeric layer 130. As described below, the moulding process 500 is described as moulding the first stiffening elastomeric layer 110 after the second stiffening elastomeric layer 120, but it will be appreciated that the moulding process 500 can be modified to mould the second stiffening elastomeric layer 120 after the first stiffening elastomeric layer 110.

As shown in FIG. 16c, the second stiffening elastomeric layer 120 is moulded while the middle mould 530 is cooling. Parts A and B of S960 silicone are weighed and mixed in a ratio of 10:1 by weight. The mixture is placed in a vacuum chamber and degassed for 5 minutes to remove bubbles in the mixture. The degassed mixture 522 is removed from the vacuum chamber. After the middle mould 530 and flat mould cap have cooled, the flat mould cap can be removed to expose the cured elastic elastomeric layer 130. The degassed mixture 522 is poured into the top mould 520. A small amount of the degassed mixture 522 may be poured on the middle mould 530 over the elastic elastomeric layer 130. The top mould 522 and middle mould 530 containing the degassed mixture 522 are placed in the vacuum chamber for final degassing for 5 minutes. The final degassing removes any remaining bubbles and allows the degassed mixture 522 to conform to the narrow channels 560 of the top mould 520. After the final degassing, the top mould 520 and middle mould 530 are clamped together via the respective markers 570 and placed in the oven to mould the second stiffening elastomeric layer 120 at 60° C. for 1 hour as well as to bond the second stiffening elastomeric layer 120 and elastic elastomeric layer 130 together. The small amount of mixture 522 on the middle mould 530 helps to prevent forming of surface voids on the second stiffening elastomeric layer 120. After moulding, the top mould 520 and middle mould 530 are removed from the oven and left to cool to cure the second stiffening elastomeric layer 120 and bond it with the elastic elastomeric layer 130.

The first stiffening elastomeric layer 110 is moulded while the top mould 520 and middle mould 530 are cooling. Parts A and B of S960 silicone are weighed and mixed in a ratio of 10:1 by weight. The mixture is placed in a vacuum chamber and degassed for 5 minutes to remove bubbles in the mixture. The degassed mixture 512 is removed from the vacuum chamber. After the top mould 520 and middle mould 530 have cooled, the middle mould 530 can be removed to expose the cured elastic elastomeric layer 130 that is bonded to the cured second stiffening elastomeric layer 120. As shown in an exploded view in FIG. 16d, the support mould 540 is coupled via the respective markers 570 to the top mould 520 over the elastic elastomeric layer 130.

As shown in FIG. 16e, the degassed mixture 512 is poured into the bottom mould 510. A small amount of the degassed mixture 512 may be poured on the support mould 540 over the elastic elastomeric layer 130. The bottom mould 510 and support mould 540 (coupled to the top mould 520) containing the degassed mixture 512 are placed in the vacuum chamber for final degassing for 5 minutes. The final degassing removes any remaining bubbles and allows the degassed mixture 512 to conform to the narrow channels 560 of the bottom mould 510. After the final degassing, the bottom mould 510, top mould 520, and support mould 540 between them are clamped together via the respective markers 570 and placed in the oven to mould the first stiffening elastomeric layer 110 at 60° C. for 1 hour as well as to bond the first stiffening elastomeric layer 110 and elastic elastomeric layer 130 together. The small amount of mixture 512 on the support mould 540 helps to prevent forming of surface voids on the first stiffening elastomeric layer 110. After moulding, the moulds 510,520,540 are removed from the oven and left to cool to cure the first stiffening elastomeric layer 110 and bond it with the elastic elastomeric layer 130.

After the moulds 510,520,540 have cooled, the moulds 510,520,540 can be removed to expose the cured and bonded elastomeric layers 110,120,130 that form the actuator 100.

As described above, the moulds 510,520,540 has the protrusions 550 and channels 560 that form the grooves 140 of the elastomeric layers 110,120,130. The moulding process 500 thus includes a step of forming the set of grooves 140 through one or more of the elastomeric layers 110,120,130, the grooves 140 arranged such that the cross-section of the elastomeric layers 110,120,130 has the wave profile around the grooves 140. The actuator 100 is extendable such that the elastomeric layers 110, 120, 130 along the wave profile become alternatingly arranged along the extended actuator 100.

As shown in FIGS. 16f and 16g, the elastomeric layers 110,120,130 can be cleaned and attached to the outer body 150, such as by adhesive (e.g. a silicone adhesive like Sil-Poxy™), and left to cure overnight. For example, the outer body 150 is a 3 mm rigid shell made of a stiff elastomeric material, such as S960 silicone. A hole 152 may be formed at the centre of the outer body 150 for insertion of a tube, e.g. a 4 mm silicone tube, for communicating pressurized fluid into the channel 160. The tube may be glued and cut flush onto the shell before gluing the first stiffening elastomeric layer 110 to the outer body 150.

Although the moulding process 500 is described as moulding the elastomeric layers 110,120,130 separately and bonding them together in separate moulding steps, it will be appreciated that the elastomeric layers 110,120,130 can be moulded in a single moulding step such that they are integrally formed with each other. Additionally, multiple actuators 100 can be fabricated using the moulding process 500, such as by using multiple sets of the moulds 510,520,540. It will be appreciated that various parameters of the moulding process 500 can be adjusted accordingly to fabricate multiple oar a large batch of actuators 100, such as increasing the degassing durations.

The moulding process 500 has been described to fabricate a three-layer actuator 100 having the first stiffening elastomeric layer 110, second stiffening elastomeric layer 120, and elastic elastomeric layer 130 in between. It will be appreciated that the size of each elastomeric layer 110,120,130 can be adjusted by changing the respective moulds 510,520,530,540. It will also be appreciated that the moulding process 500 can be modified to fabricate an actuator 100 with more elastomeric layers, i.e. increasing the number of middle layers in between the first and second stiffening elastomeric layers 110,120.

In some embodiments, the middle layers include at least one third stiffening elastomeric layer 170 and at least one elastic elastomeric layer 130 that is more elastic than the stiffening elastomeric layers 110,120,170. For example, the at least one third stiffening elastomeric layer 170 may have the same stiffness as the first and second stiffening elastomeric layers 110,120, the same stiffness being stiffer than that of the at least one elastic elastomeric layer 130. Within the middle layers, the at least one third stiffening elastomeric layer 170 and the at least one elastic elastomeric layer 130 may be alternatingly arranged. For example, there is one third stiffening elastomeric layer 170 disposed between two elastic elastomeric layers 130. For example, there is one elastic elastomeric layer 130 disposed between two third stiffening elastomeric layers 170.

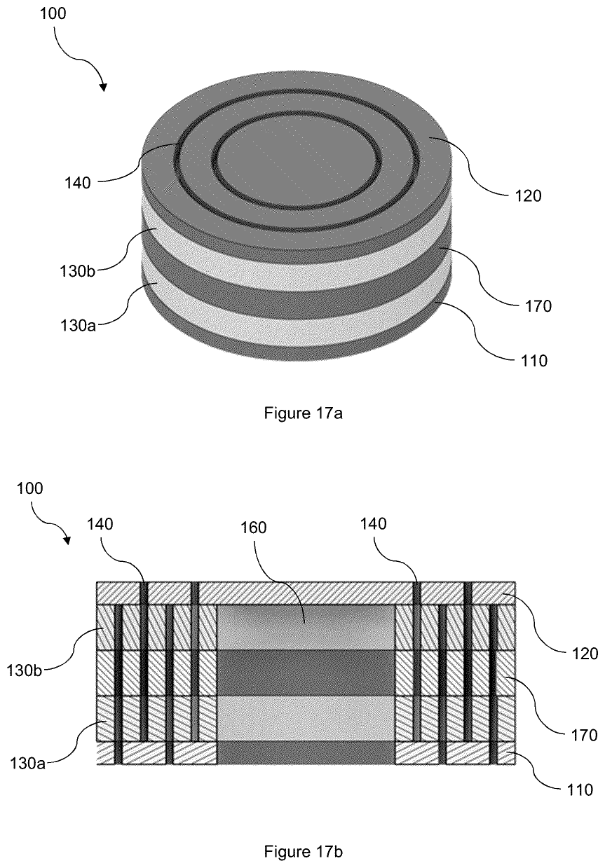

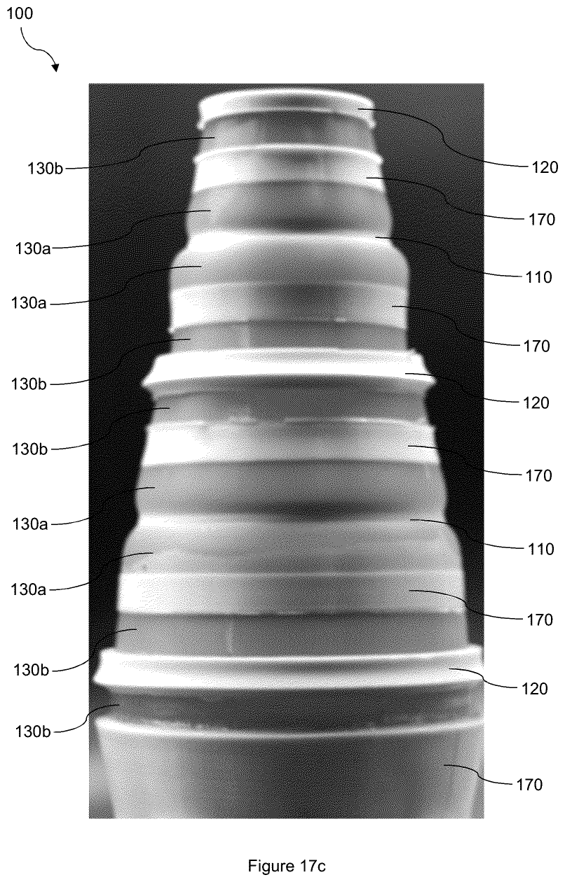

In one embodiment as shown in FIGS. 17a to 17c, the actuator 100 may have five layers and may be denoted as a “large MEA” design. The five layers include the first and second stiffening elastomeric layers 110,120 and the middle layers between them. The middle layers include a first elastic elastomeric layer 130a disposed on the first stiffening elastomeric layer 110, a second elastic elastomeric layer 130b disposed on the second stiffening elastomeric layer 120, and a third stiffening elastomeric layer 170 disposed between the first and second elastic elastomeric layers 130. Notably, the first and second elastic elastomeric layers 130 are more elastic than the first to third stiffening elastomeric layers 110,120,170.

In the unextended state, the large MEA actuator 100 has an overall diameter of 92 mm and an overall depth of 40 mm. The number of grooves 140, and hence the number of ring sections of each elastomeric layer 110,120,130,170, can be adjusted. For example, a larger overall diameter can accommodate more grooves 140. The gap of the grooves 140 between the ring sections may also be increased if the actuator 100 is thicker to facilitate unfolding, extension, and retraction of the actuator 100. Similar to the MEA design, in the large MEA actuator 100, the grooves 140 are formed through one or more of the elastomeric layers 110,120,130,170 and the grooves 140 are arranged such that the cross-section of the elastomeric layers 110,120,130,170 includes the wave profile around the grooves 140. In the extended state, the elastomeric layers 110,120,130,170 along the wave profile become alternatingly arranged along the extended actuator 100.

### Actuator 3D Printing

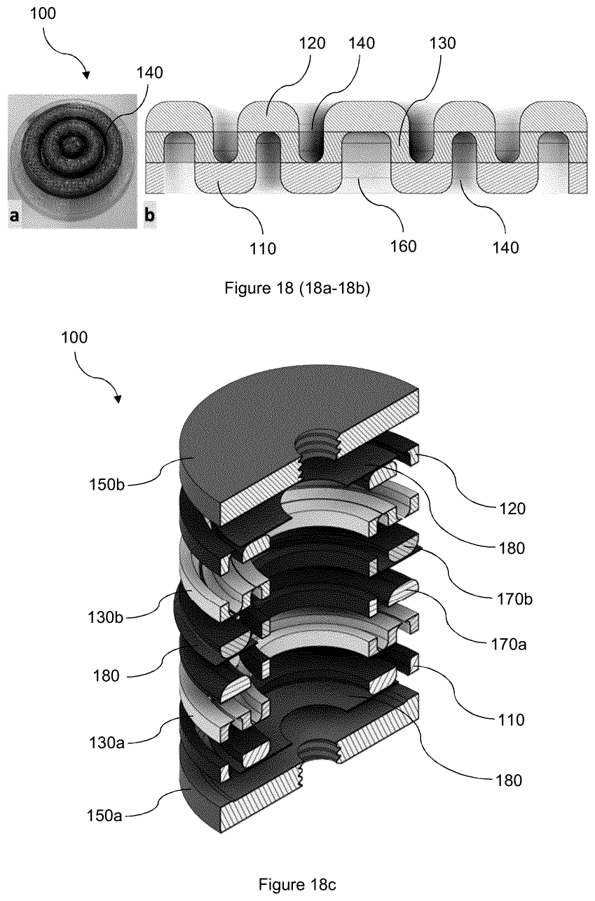

In some embodiments, the actuator 100 is fabricated by additive manufacturing or 3D printing such as Fused Deposition Modelling (FDM). The soft material filaments available for 3D printing the actuator 100 have a higher Shore hardness ranging from 60A to 95A compared to those for the moulded actuator 100 from the moulding process 500 which ranges from 00-30 to 60A. As shown in FIGS. 18a and 18b. The 3D-printed actuator 100 follows closely to the dimensions of the MEA design. However, the gap of the grooves 140 was increased to 2 mm because 0.8 mm gaps are too narrow for 3D printing which would have caused the material filaments to fuse during printing. Further, the width of the elastic elastomeric layer 130 was decreased to 1.2 mm and the corners of the elastomeric layers 110,120,130 along the wave profile are rounded/filleted to increase the bonding area between the elastomeric layers 110,120,130 when they are printed layer by layer during 3D printing.

Three exemplary material filaments can be used to print the 3D-printed actuator 100, namely X60 filament from Diabase Engineering, NinjaFlex (NF) filament from NinjaTek, and Armadillo filament from NinjaTek. X60 has a Shore hardness of 60A and NF has a Shore hardness of 85A. Armadillo is a rigid TPU with a Shore hardness of 75D. Four variations of the 3D-printed actuator 100 were fabricated for testing—(i) X60 variation wherein all elastomeric layers 110,120,130 were printed with X60 filaments; (ii) NF variation wherein all elastomeric layers 110,120,130 were printed with NF filaments; (iii) X60-NF-X60 variation wherein the stiffening elastomeric layers 110, 120 were printed with X60 filaments and the elastic elastomeric layer 130 was printed with NF filaments; and (iv) NF-X60-NF variation wherein the stiffening elastomeric layers 110,120 were printed with NF filaments and the elastic elastomeric layer 130 was printed with X60 filaments. Each 3D-printed actuator 100 further includes the outer body 150 that was printed with Armadillo filaments.

In one embodiment as shown in FIG. 18c, the 3D-printed actuator 100 may have additional stiffening and elastic elastomeric layers. More specifically, the 3D-printed actuator 100 includes, in sequence, a first stiffening elastomeric layer 110, a first elastic elastomeric layer 130a, two third stiffening elastomeric layers 170a, 170b, a second elastic elastomeric layer 130b, and a second stiffening elastomeric layer 120. The 3D-printed actuator 100 further includes two outer bodies 150a, 150b on both ends to seal the actuator 100. Further, to prevent a layer from bonding to unnecessary areas of another layer, a number of separation layers 180 may be disposed between the respective layers. For example, separation layers 180 are disposed between the outer body 150a and the first stiffening elastomeric layer 110, between the third stiffening elastomeric layers 170a, 170b, and between the outer body 150b and the second stiffening elastomeric layer 120. The separation layers 180 are shaped such that the respective layers bond to each other, by the 3D printing, at the required areas outside of the respective separation layer 180. The separation layers 180 may include painter tapes or masking tapes.

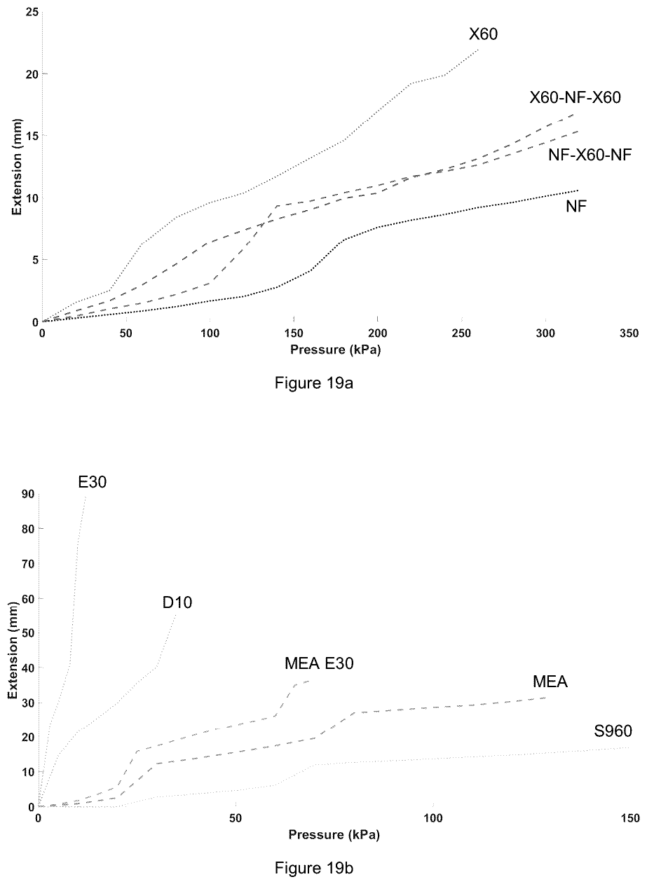

The 3D-printed actuators 100 were tested on their extensibility with respect to input pressure and the test results were compared to the moulded silicone actuators 100, as shown in FIGS. 19a and 19b, respectively. It was observed that the 3D-printed actuators 100 can withstand significantly higher pressures than the moulded silicone actuators 100. For example, the X60 actuator 100 can withstand almost double the pressure compared to the S960 actuator 100, despite both X60 and S960 materials having the same Shore hardness of 60A. The X60 actuator 100 was able to withstand a maximum input pressure of 260 kPa and achieve a maximum extension of 21.93 mm which is about 365% of the original depth of 6 mm. The NF actuator 100 was able to withstand a maximum input pressure of at least 320 kPa and achieve a maximum extension of 10.59 mm which is about 177% of the original depth 6 mm.

The X60-NF-X60 actuator 100 was able to withstand a maximum input pressure of at least 320 kPa and achieve a maximum extension of 16.92 mm which is about 282% of the original depth. The NF-X60-NF actuator 100 was able to withstand a maximum input pressure of at least 320 kPa and achieve a maximum extension of 15.35 mm which is about 256% of the original depth. It was also observed that the X60-NF-X60 actuator 100 extended more than the NF-X60-NF actuator 100 at lower input pressures, likely due to the NF-X60-NF actuator 100 having NF has the stiffening elastomeric layers 110,120 which increased the initial tension to overcome. Once the initial tension was overcome, the extensions were similar for both X60-NF-X60 and NF-X60-NF actuators 100.

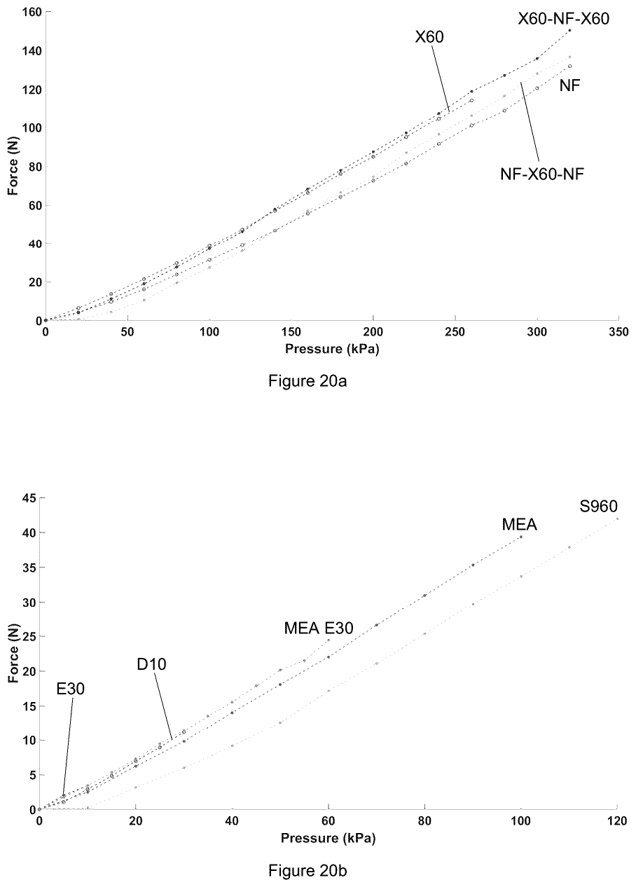

The 3D-printed actuators 100 were also tested on their force output with respect to input pressure and the test results were compared to the moulded silicone actuators 100, as shown in FIGS. 20a and 20b, respectively. As the 3D-printed actuators 100 can withstand significantly higher pressures and the contact area at the end of the actuators 100 is the same, the 3D-printed actuators 100 can achieve significantly higher force outputs compared to the moulded silicone actuators 100. As shown in FIG. 20a, at the respective maximum input pressure, the X60, NF, X60-NF-X60, and NF-X60-NF actuators 100 achieved a maximum force output of 114.2 N, 131.9 N, 150.2 N, and 136.6 N, respectively.

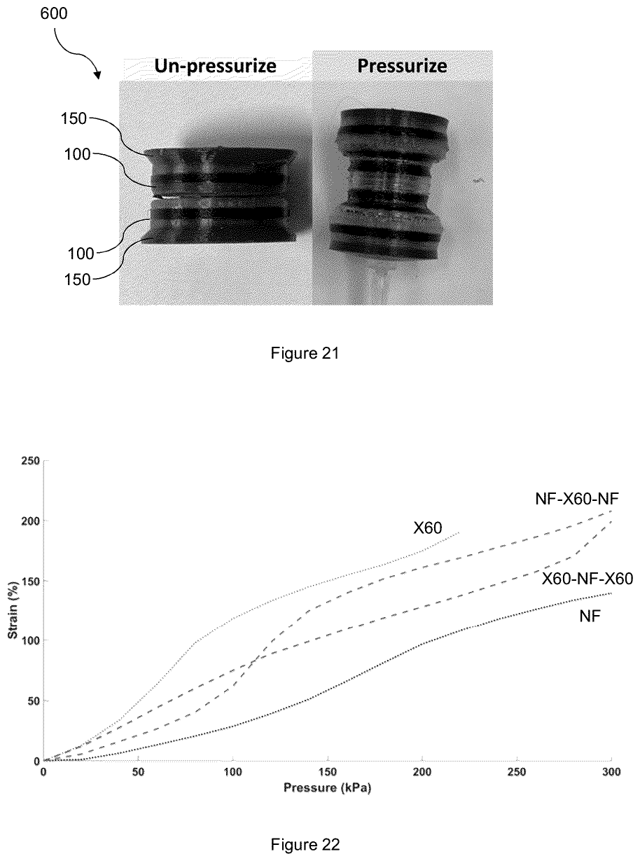

A plurality of 3D-printed actuators 100 can be combined to form a 3D-printed AMU 600, similar to the AMU 410 formed from the moulded silicone actuators 100. As shown in FIG. 21, two 3D-printed actuators 100 can be joined to form the 3D-printed AMU 600 with the Dual Inverted MEA design and an original depth of 12 mm. Each 3D-printed actuator 100 has the X60-NF-X60 variation and includes the Armadillo outer body 150. The Armadillo outer body 150 helps to seal the actuator 100 at the first stiffening elastomeric layers 110. Armadillo does not deform under high pressure and can help to achieve better results than the moulded silicone actuators 100 that use silicone glue which has a pressure limitation of 150 kPa.

As shown in FIG. 22, the 3D-printed AMUs 600 were tested on their strain with respect to input pressure and the test results were compared to the other 3D-printed AMUs 600 formed with 3D-printed actuators 100 of the other three variations (X60, NF, and NF-X60-NF). It was observed that all four variations of the 3D-printed AMUs 600 were able to withstand high pressures of at least 300 kPA except for the X60 AMU 600 which failed earlier. It was also observed that the X60-NF-X60 AMU 600 extended more than the NF-X60-NF AMU 600 at lower input pressures, likely due to the NF-X60-NF AMU 600 having higher initial tension that required higher initial input pressure to overcome. Once the initial tension was overcome, the NF-X60-NF AMU 600 performed better than the X60-NF-X60 AMU 600, evidently showing that the X60 material for the elastic elastomeric layers 130 improved extensibility.

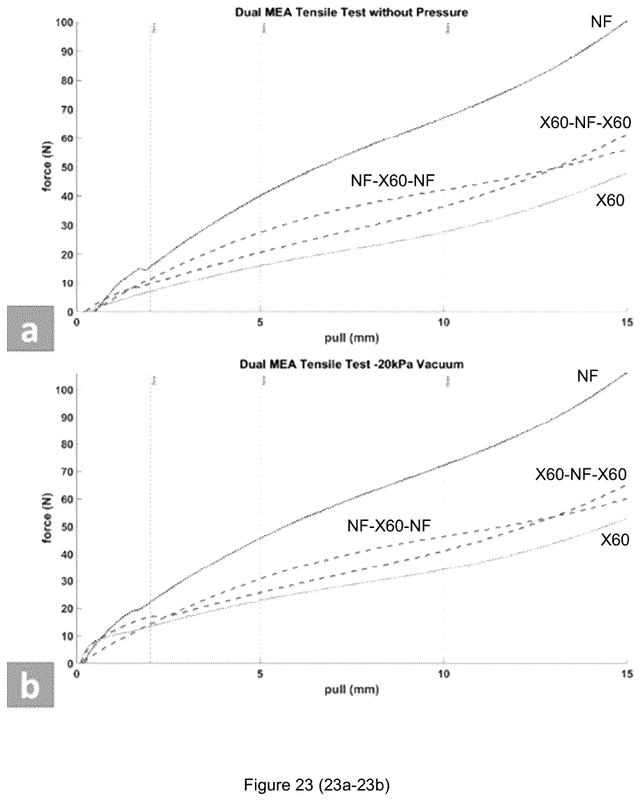

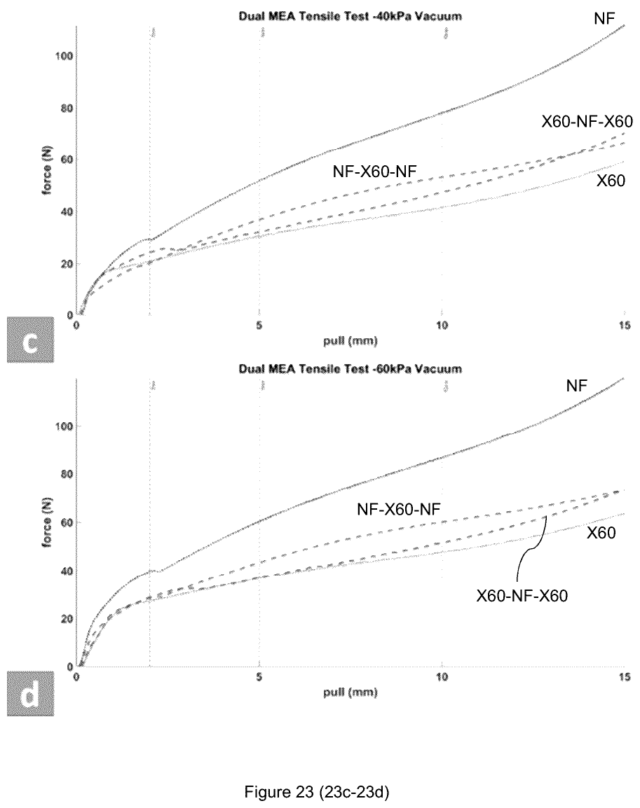

Pull force tests were also performed on the four 3D-printed AMUs 600. The 3D-printed AMUs 600 were pulled and the pulling force was measured with respect to the pulling distance. The tests were conducted using vacuum pressures at 0 kPa, −20 kPa, −40 kPa, and −60 kPa, as shown respectively in the test results in FIGS. 23a to 23d. The test results show that increasing the vacuum pressure increases the pulling force for the same pulling distance. For example, at the 2 mm pulling distance, the pulling force approximately doubled when the vacuum pressure was increased from −20 kPa to −60 kPa. At the 2 mm pulling distance, there was minimal difference in the pulling forces of the X60-NF-X60 and NF-X60-NF AMUs 600. When the pulling distance was increased over 2 mm, the NF-X60-NF AMU 600 achieved higher pulling force compared to the X60-NF-X60 AMU 600.

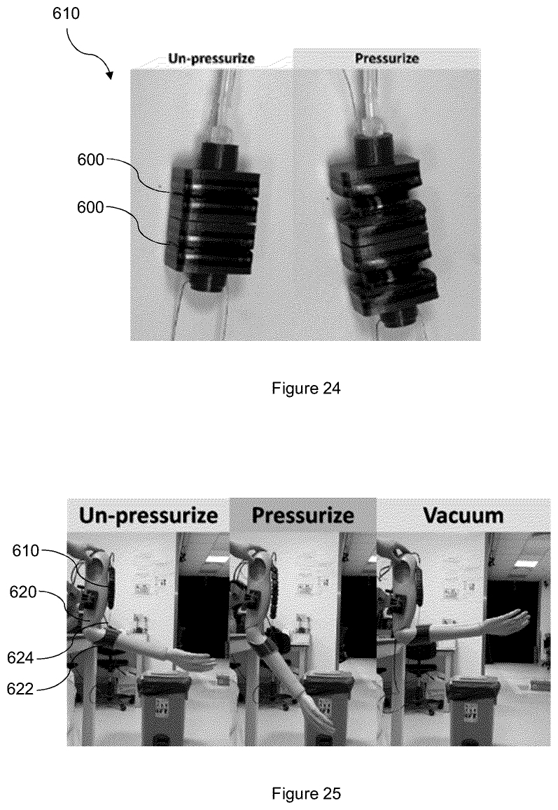

A plurality of 3D-printed AMUs 600 can be combined to form a combined AMU 610. As shown in FIG. 24, two 3D-printed AMUs 600 of the Dual MEA design can be joined to form the combined AMU 610. The combined AMU 610 may be referred to as a Bicep AMU (BAMU) 610 to simulate the bicep muscle of a human arm. It will be appreciated that multiple AMUs 600 and/or BAMUs 610 can be combined in series and/or parallel to improve extension and/or force output.

As shown in FIG. 25, an exemplary BAMU 610 having a series of AMUs 600 was tested as a potential elbow assistive device. The BAMU 610 was coupled to a mannequin or dummy arm 620 to simulate the bicep muscle and test the elbow flexion and extension upon negative and positive pressure, respectively. A sleeve 622 was worn on the forearm of the dummy arm 620 and the BAMU 610 was fixed at the upper arm of the dummy arm 620. The BAMU 610 was connected to the sleeve 622, such as using a nylon fabric or wire 624. In the unpressurized state, the BAMU 610 was unextended and was able to hold the forearm having a weight of 0.55 kg. In the vacuum state when the BAMU 610 was subjected to vacuum pressure, the BAMU 610 was able to increase elbow flexion and bend the forearm further upwards compared to the unpressurized state. In the pressurized state when the BAMU 610 was subjected to positive pressure, the BAMU 610 was extended and the forearm flexes back downwards due to elbow extension.

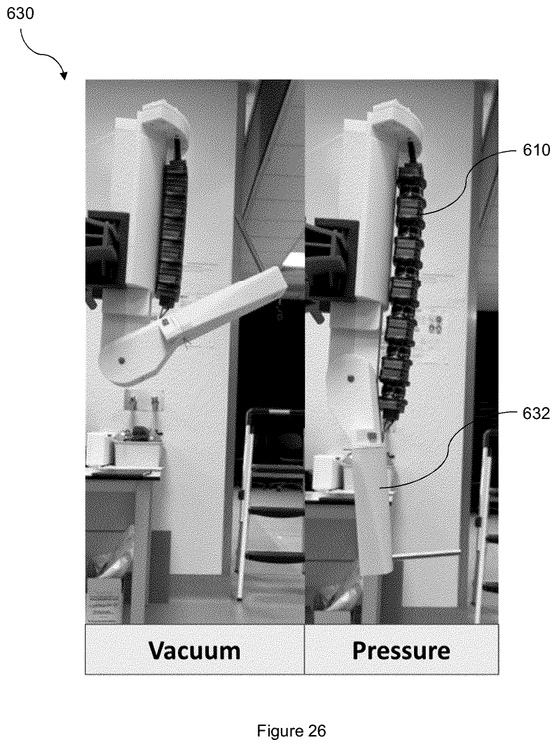

As shown in FIG. 26, the BAMU 610 was coupled to an arm assembly 630 to test the speed of extending the distal arm 632. The BAMU 610 was initially under a vacuum pressure of −60 kPa to maintain the distal arm 632 in the flexed position. The BAMU 610 was then pressurized to 200 kPa. It was found that the distal arm 632 extended back to the original extended position in approximately 0.461 seconds.

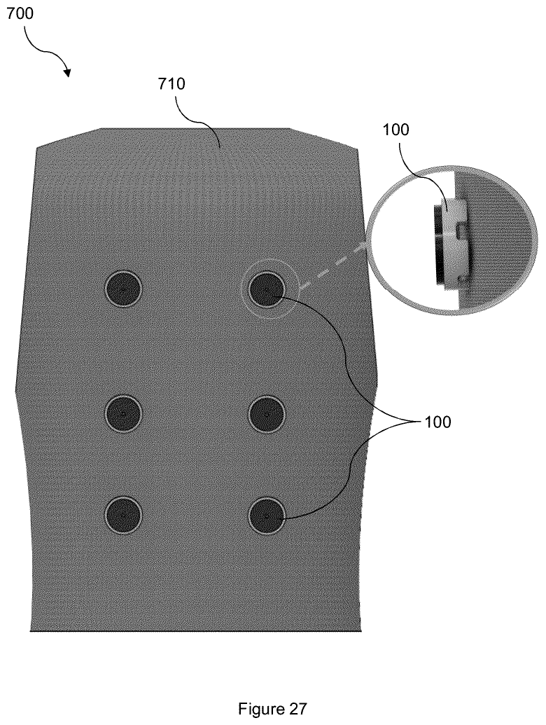

Some other applications of the actuator 100 include embedding the actuators 100 in garments 700 to provide haptic feedback. As shown in FIG. 27, a garment 700 may include a body vest 710 having an array of actuators 100 embedded therein. When the body vest 710 is worn on a user, the actuators 100 are in the unextended state and hover above the skin to prevent the user from feeling the actuators 100 constantly. When an actuator 100 is extended such as in response to a command signal, the user would feel the impact force of the extended actuator 100 coming into contact with the skin. The actuators 100 can thus be used to provide haptic feedback to the user, such as when the user is playing a character in a game and the character receives damage during the game. The garments 700 may alternatively include other wearable items such as head gears, hand gloves, etc. Such applications of haptic feedback by the actuators 100 can provide more seamless, intuitive, and immersive experiences in gaming and other simulated environments such as augmented/virtual reality, such as for simulating body damage in these environments.

### Additive Manufacturing/3D Printing

As described above, the actuator 100 can be fabricated by various manufacturing methods. In some embodiments, the actuator 100 or parts thereof or a product comprising the actuator 100 or parts thereof may be formed by a manufacturing process that includes an additive manufacturing process. A common example of additive manufacturing is 3D printing; however, other methods of additive manufacturing are available. Rapid prototyping or rapid manufacturing are also terms which may be used to describe additive manufacturing processes.

As used herein, “additive manufacturing” refers generally to manufacturing processes wherein successive layers of material(s) are provided on each other to “build-up” layer-by-layer or “additively fabricate”, a 3D component. This is compared to some subtractive manufacturing methods (such as milling or drilling), wherein material is successively removed to fabricate the part. The successive layers generally fuse together to form a monolithic component which may have a variety of integral sub-components. In particular, the manufacturing process may allow an example of the disclosure to be integrally formed and include a variety of features not possible when using prior manufacturing methods.

Additive manufacturing methods described herein enable manufacture to any suitable size and shape with various features which may not have been possible using prior manufacturing methods. Additive manufacturing can create complex geometries without the use of any sort of tools, moulds, or fixtures, and with little or no waste material. Instead of machining components from solid billets of plastic or metal, much of which is cut away and discarded, the only material used in additive manufacturing is what is required to shape the part.

Suitable additive manufacturing techniques in accordance with the present disclosure include, for example, Fused Deposition Modelling (FDM), Selective Laser Sintering (SLS), 3D printing such as by inkjets and laserjets, Stereolithography (SLA), Direct Selective Laser Sintering (DSLS), Electron Beam Sintering (EBS), Electron Beam Melting (EBM), Laser Engineered Net Shaping (LENS), Electron Beam Additive Manufacturing (EBAM), Laser Net Shape Manufacturing (LNS), Direct Metal Deposition (DMD), Digital Light Processing (DLP), Continuous Digital Light Processing (CDLP), Direct Selective Laser Melting (DSLM), Selective Laser Melting (SLM), Direct Metal Laser Melting (DMLM), Direct Metal Laser Sintering (DMLS), Material Jetting (MJ), NanoParticle Jetting (NPJ),

Drop On Demand (DOD), Binder Jetting (BJ), Multi Jet Fusion (MJF), Laminated Object Manufacturing (LOM), and other known processes.

The additive manufacturing processes described herein may be used for forming components using any suitable material. For example, the material may be plastic, polymer, composite, or any other suitable material that may be in solid, liquid, powder, sheet material, wire, or any other suitable form or combinations thereof. More specifically, according to exemplary embodiments of the present disclosure, the additively manufactured components described herein may be formed in part, in whole, or in some combination of materials suitable for use in additive manufacturing processes and which may be suitable for the fabrication of examples described herein.

As noted above, the additive manufacturing process disclosed herein allows a single component to be formed from multiple materials. Thus, the examples described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

Additive manufacturing processes typically fabricate components based on 3D information, for example a 3D computer model (or design file), of the component. Accordingly, examples described herein not only include products or components as described herein, but also methods of manufacturing such products or components via additive manufacturing and computer software, firmware or hardware for controlling the manufacture of such products via additive manufacturing.

The structure of the product may be represented digitally in the form of a design file. A design file, or computer aided design (CAD) file, is a configuration file that encodes one or more of the surface or volumetric configuration of the shape of the product. That is, a design file represents the geometrical arrangement or shape of the product.

Design files can take any now known or later developed file format. For example, design files may be in the Stereolithography or “Standard Tessellation Language” (.stl) format which was created for Stereolithography CAD programs of 3D Systems, or the Additive Manufacturing File (amf) format, which is an American Society of Mechanical Engineers (ASME) standard that is an extensible markup-language (XML) based format designed to allow any CAD software to describe the shape and composition of any 3D object to be fabricated on any additive manufacturing printer. Further examples of design file formats include AutoCAD (.dwg) files, Blender (.blend) files, Parasolid (.x_t) files, 3D Manufacturing Format (.3mf) files, Autodesk (3ds) files, Collada (.dae) files and Wavefront (.obj) files, although many other file formats exist.

Design files can be produced using modelling (e.g. CAD modelling) software and/or through scanning the surface of a product to measure the surface configuration of the product. Once obtained, a design file may be converted into a set of computer executable instructions that, once executed by a processer, cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. As discussed above, the formation may be through deposition, through sintering, or through any other form of additive manufacturing method.

The code or instructions may be translated between different formats, converted into a set of data signals and transmitted, received as a set of data signals and converted to code, stored, etc., as necessary. The instructions may be an input to the additive manufacturing system and may come from a part designer, an intellectual property (IP) provider, a design company, the operator or owner of the additive manufacturing system, or from other sources. An additive manufacturing system may execute the instructions to fabricate the product using any of the technologies or methods disclosed herein.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions defining the product that can be used to physically generate the object, upon execution of the code or instructions by an additive manufacturing system. For example, the instructions may include a precisely defined 3D model of the product and can be generated from any of a large variety of well-known CAD software systems such as AutoCAD®, TurboCAD®, DesignCAD 3D Max, etc. Alternatively, a model or prototype of the product may be scanned to determine the 3D information of the product. Accordingly, by controlling an additive manufacturing apparatus according to the computer executable instructions, the additive manufacturing apparatus can be instructed to print out the product.

In light of the above, embodiments include methods of manufacture via additive manufacturing. This includes the steps of obtaining a design file representing the product and instructing an additive manufacturing apparatus to manufacture the product according to the design file. The additive manufacturing apparatus may include a processor that is configured to automatically convert the design file into computer executable instructions for controlling the manufacture of the product. In these embodiments, the design file itself can automatically cause the production of the product once input into the additive manufacturing apparatus. Accordingly, in this embodiment, the design file itself may be considered computer executable instructions that cause the additive manufacturing apparatus to manufacture the product. Alternatively, the design file may be converted into instructions by an external computing system, with the resulting computer executable instructions being provided to the additive manufacturing apparatus.

Given the above, the design and manufacture of implementations of the subject matter and the operations described in this specification can be realized using digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or other manufacturing technology.

In the foregoing detailed description, embodiments of the present disclosure in relation to a multilayer extendable actuator are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A multilayer extendable actuator comprising:
a first stiffening elastomeric layer;
a second stiffening elastomeric layer;
a set of middle layers disposed between the stiffening elastomeric layers, the middle layers comprising an elastic elastomeric layer that is more elastic than the stiffening elastomeric layers; and
a set of grooves through one or more of the elastomeric layers, the grooves arranged such that a cross-section of the elastomeric layers comprises a wave profile around the grooves,
wherein the actuator is extendable such that the elastomeric layers along the wave profile become alternatingly arranged along the extended actuator.

2. The actuator according to claim 1, wherein the wave profile comprises a square wave profile.

3. The actuator according to claim 1, further comprising a channel extending through at least the first stiffening elastomeric layer for receiving pressurized fluid for extending the actuator.

4. The actuator according to claim 3, wherein the channel extends further through the elastic elastomeric layer.

5. The actuator according to claim 1, further comprising an outer body for supporting the elastomeric layers, wherein the first stiffening elastomeric layer is attached to the outer body.

6. The actuator according to claim 1, wherein the elastomeric layers are integrally formed with each other, or the elastomeric layers are separately formed and bonded to each other.

7. The actuator according to claim 1, wherein the middle layers comprise:
at least one third stiffening elastomeric layer; and
at least one elastic elastomeric layer that is more elastic than the stiffening elastomeric layers.

8. The actuator according to claim 7, wherein the at least one third stiffening elastomeric layer and the at least one elastic elastomeric layer are alternatingly arranged.

9. The actuator according to claim 7, wherein the middle layers comprise:
a first elastic elastomeric layer disposed on the first stiffening elastomeric layer;
a second elastic elastomeric layer disposed on the second stiffening elastomeric layer; and
a third stiffening elastomeric layer disposed between the first and second elastic elastomeric layers,
wherein the first and second elastic elastomeric layers are more elastic than the first to third stiffening elastomeric layers.

10. An extendable actuation device comprising a plurality of the actuators according to claim 1.

11. The actuation device according to claim 10, wherein the actuators are disposed successively on each other in series.

12. The actuation device according to claim 11, comprising two of the actuators disposed successively on each other, wherein the first stiffening elastomeric layers of two successive actuators are arranged to face each other.

13. The actuation device according to claim 11, comprising two of the actuators disposed successively on each other, wherein the second stiffening elastomeric layers of two successive actuators are arranged to face each other.

14. An actuation assembly comprising:
a set of arms;
a set of the actuators according to claim 1, the actuators connected to the arms for actuating the arms.

15. The actuation assembly according to claim 14, wherein the arms comprise a pair of finger modules to form a gripper assembly.

16. The actuation assembly according to claim 14, wherein the arms comprise a proximal arm and a distal arm hinged to the proximal arm to form a modular arm assembly, wherein the actuators are configured to actuate the distal arm.

17. An actuation robot comprising four sets of actuation assemblies, each actuation assembly comprising:
a leg; and
the actuator according to claim 1, the actuator connected to the leg for actuating the leg,
wherein the legs of the actuation robot are cooperatively actuatable to move the actuation robot.

18. A method for fabricating a multilayer extendable actuator, the method comprising:
moulding a set of middle layers comprising an elastic elastomeric layer;
moulding one of a first and second stiffening elastomeric layers and bonding it to the elastic elastomeric layer;
moulding the other of the first and second stiffening elastomeric layers and bonding it to the elastic elastomeric layer that is more elastic than the stiffening elastomeric layers; and
forming a set of grooves through one or more of the elastomeric layers, the grooves arranged such that a cross-section of the elastomeric layers comprises a wave profile around the grooves,
wherein the actuator is extendable such that the elastomeric layers along the wave profile become alternatingly arranged along the extended actuator.

19. A computer program comprising computer executable instructions that, when executed by a processor, cause the processor to control an additive manufacturing apparatus to manufacture a product comprising the actuator according to claim 1.

20. A method of manufacturing a product via additive manufacturing, the method comprising:
obtaining an electronic file representing a geometry of the product wherein the product comprises the actuator according to claim 1; and
controlling an additive manufacturing apparatus to manufacture, over one or more additive manufacturing steps, the product according to the geometry specified in the electronic file.
